(19) United States
(12) Patent Application Publication
(10) Pub. No.: US 2026/0075636 A1
(43) Pub. Date: Mar. 12, 2026

(54) RESOURCE TYPES WITH DIFFERENT PRIORITIES FOR DATA FLOW IN WIRELESS COMMUNICATIONS SYSTEMS

(71) Applicant: Sharp Kabushiki Kaisha, Sakai City, Osaka (JP)

(72) Inventors: Sangkyu BAEK, Vancouver, WA (US); Atsushi ISHII, Vancouver, WA (US)

(21) Appl. No.: 18/827,320

(22) Filed: Sep. 6, 2024

(51) Int. Cl. H04W 72/563; H04W 72/1268; H04W 72/54; H04W 76/20

(52) U.S. Cl. CPC H04W 72/563; H04W 72/1268; H04W 72/54; H04W 76/20

(57) ABSTRACT

A network node of a telecommunications system comprises node processor circuitry and node interface circuitry. The node processor circuitry is configured to configure plural resource types for a data flow between the network node and a wireless terminal and differing priorities for at least two of the resource types of the data flow. The node interface circuitry is configured to transmit to the wireless terminal a message that identifies the plural resource types for the data flow and the differing priorities for the at least two of the resource types of the data flow. A wireless terminal comprises terminal interface circuitry which is configured to receive the message from the network node and terminal processor circuitry configured to use the plural resource types for the data flow and the priority of the at least one resource type of the data flow to communicate with the network node.

### TECHNICAL FIELD

The technology relates to wireless communications, and particularly to resource utilization in wireless communication networks.

### BACKGROUND

A radio access network typically resides between wireless devices, such as user equipment (UEs), mobile phones, mobile stations, or any other device having wireless termination, and a core network. Example of radio access network types includes the GRAN, GSM radio access network; the GERAN, which includes EDGE packet radio services; UTRAN, the UMTS radio access network; E-UTRAN, which includes Long-Term Evolution; and NG-UTRAN, the New Radio (NR).

A radio access network may comprise one or more access nodes, such as base station nodes, which facilitate wireless communication or otherwise provides an interface between a wireless terminal and a telecommunications system. A non-limiting example of a base station can include, depending on radio access technology type, a Node B (“NB”), an enhanced Node B (“eNB”), a home eNB (“HeNB”), a gNB (for a New Radio [“NR”] technology system), or some other similar terminology.

The 3rd Generation Partnership Project (“3GPP”) is a group that, e.g., develops collaboration agreements such as 3GPP standards that aim to define globally applicable technical specifications and technical reports for wireless communication systems. Various 3GPP documents may describe certain aspects of radio access networks. Overall architecture for a fifth-generation system, e.g., the 5G System, also called “NR” or “New Radio”, as well as “NG” or “Next Generation”, is shown in FIG. 1, and is also described in 3GPP TS 38.300. The 5G NR network is comprised of NG RAN (Next Generation Radio Access Network) and 5GC (5G Core Network). As shown, NGRAN is comprised of gNBs (e.g., 5G Base stations) and ng-eNBs (i.e. LTE base stations). An Xn interface exists between gNB-gNB, between (gNB)-(ng-eNB) and between (ng-eNB)-(ng-eNB). The Xn is the network interface between NG-RAN nodes. Xn-U stands for Xn User Plane interface and Xn-C stands for Xn Control Plane interface. A NG interface exists between 5GC and the base stations (i.e. gNB & ng-eNB). A gNB node provides NR user plane and control plane protocol terminations towards the UE and is connected via the NG interface to the 5GC. The 5G NR (New Radio) gNB is connected to AMF (Access and Mobility Management Function) and UPF (User Plane Function) in 5GC (5G Core Network).

In 3GPP wireless communication systems, a Medium Access Control, MAC, control element, CE, herein referred to as “MAC CE” is a way of control signaling at the MAC sublayer. MAC CEs are multiplexed in a MAC protocol data unit, e.g., MAC PDU, together with user data, e.g., in a MAC service data unit, SDU. A MAC CE requires that its MAC subheader indicate the relevant information of the MAC CE. For example, a Logical Channel Identity, LCID, in the subheader indicates the type of the MAC CE. For the variable-sized MAC CE, a length field, L, in the subheader indicates the total size of the MAC CE. Based on the header information, the sender and receiver are able to exchange the MAC CE successfully. in addition to the L and LCID fields, the MAC subheader also includes a format field, F, and a reserved field, R.

Carrier aggregation (CA) is designed to increase the data rate per user by configuring the mobile terminal to be simultaneously connected with multiple cells of the serving base station, which makes the mobile terminal, or user equipment (UE), operate at multiple frequencies at the same time. With Dual Connectivity (DC), the mobile terminal can be simultaneously connected to two serving base stations (known as the master node, MN, and the secondary node, SN).

New Radio, 5G, communications systems support various types of services like enhanced mobile broadband, eMBB, ultra-reliable and low-latency communications, URLLC, and massive machine type communications, mMTC. For services such as those mentioned 5G NR requires resource separation based on different quality of service, QoS, requirements, such as data rate, latency, reliability and so on. More specifically, data flow or traffic flows, which are called QoS flows in NR, with similar QoS requirements use common resources whereas other traffic flows use different resources.

For uplink transmission, e.g., transmission from a wireless terminal, UE, to a network node, e.g., a gNB), resource separation is enabled by a Logical Channel (LCH) Mapping Restriction which configures allowed resources that each logical channel may use. Logical Channel (LCH) Mapping Restriction is described, e.g., in 3GPP TS 38.321 V18.2.0 (2024-06), 3rd Generation Partnership Project; Technical Specification Group Radio Access Network; NR; Medium Access Control (MAC) protocol specification (Release 18), which is incorporated herein by reference, including clauses 5.4.3.1.1 and 5.4.3.1.2 thereof. Currently, there are seven LCH mapping restrictions as follows:
allowedSCS-List which sets the allowed Subcarrier Spacing(s) for transmission;
maxPUSCH-Duration which sets the maximum PUSCH duration allowed for transmission;
configuredGrantType1Allowed which sets whether a configured grant Type 1 can be used for transmission;
allowedServingCells which sets the allowed cell(s) for transmission;
allowedCG-List which sets the allowed configured grant(s) for transmission;
allowedPHY-PriorityIndex which sets the allowed PHY priority index(es) of a dynamic grant for transmission;
allowedHARQ-mode which sets the allowed UL HARQ mode for transmission.

If at least one of the LCH mapping restrictions is configured for a logical channel, the logical channel is allowed to use the resources according to the restriction. The logical channel mapping restriction is configured by an RRC message. More specifically, an information element known as logicalChannelConfig provides the logical channel mapping restrictions.

When a UE receives an uplink grant, e.g., a grant of uplink resources for data transmission, all the logical channels allowed to use the uplink grant participates in a Logical Channel Prioritization, LCP, procedure which decides the exact amount of resource that each logical channel uses. During LCP, logical channels with higher logical channel priority are prioritized. Each logical channel has its logical channel priority classified as one of 16 steps of priority value where 1 is the highest priority and 16 is the lowest priority.

The logical channel priority is configured by an RRC message. More specifically, the information element logicalChannelConfig provides the logical channel priority.

The current practice of using Logical Channel (LCH) Mapping Restriction to configure allowed resources for each logical channel involves several problems, three of which are described briefly below.

A first problem associated with the current practice of using Logical Channel (LCH) Mapping Restriction is that all types of resources have only a single priority value. Although resource separation provides a dedicated uplink grant (resource) for each logical channel, it leads to resource waste when the data arrival is variable-sized or it experiences jitter. FIG. 2 depicts an example of resource waste of resource separation. In FIG. 2, two logical channels, namely LCH 4 and LCH 6 are configured. Both LCHs serve URLLC traffic flows, so the LCHs have dedicated resources, e.g., dedicated configured grant, CGresources in the example. LCH 4 has priority value 1 and CG1 as its allowed dedicated CG resource, CG. LCH 6 has priority value 2 and CG2 as its allowed CG. In the example, LCH4 has relatively large amount of data to be transmitted but LCH6 does not have much data. Since LCH 2 is only allowed to use CG2, the remaining resource after all buffered data for LCH 6 uses the CG2 resource is filled with padding. Thus, the CG2 resource is considered as a resource waste.

FIG. 3 shows another problem if LCH 4 were allowed to use CG2 to avoid the resource waste shown in FIG. 2 In the example of FIG. 3, LCH 4 has priority value 1 and CG1 and CG2 as its allowed CG, e.g., the dedicated CG resource. LCH 6 has priority value 2 and CG2 as its only allowed CG. In the case of FIG. 3, CG2 does not have a resource waste. However, LCH4 with higher priority uses more data than LCH6 with lower priority. Only a small amount of data of LCH 6 can use the CG2 resource, so most of data of LCH6 will experience delays. Moreover, if all data of LCH4 are transmitted by previous CG1 and CG2, later CG1 resource is filled with padding. So FIG. 3 illustrates another example of resource waste.

A root cause of resource waste and inefficiency such as that illustrated in FIG. 2 and FIG. 3 is that each logical channels uses a single LCH priority value regardless of resource type, e.g., uses a single LCH priority value regardless of the uplink grants which the logical channel is allowed to use.

A second problem associated with the current practice of using Logical Channel (LCH) Mapping Restriction is a limitation of jointly applied LCH mapping restrictions. For example, if multiple LCH mapping restrictions are configured for a logical channel, the resource which satisfies all restrictions can be used by the logical channel. For example, suppose that 15 KHz is included in allowedSCS-List and PCell is included in allowedServingCells. In this case, the logical channel is allowed to use a resource whose subcarrier spacing, SCS, is 15 KHz and the resource is on a primary cell, PCell. However, it is not possible to configure both 15 KHz on PCell and 30 KHz on a secondary cell, SCell1.

A third problem associated with the current practice of using Logical Channel (LCH) Mapping Restriction involves Static LCH priority. Currently, LCH priority is configured by an RRC message and it is not dynamically changed. But the network may need to change one priority value to another priority value, by considering whether each QoS flow of a logical channel meets its QoS requirement and/or QoS status. e.g., data rate, delay, etc.

What is needed are methods, apparatus, and/or techniques to address one or more of the above-described problems.

### SUMMARY

In one of its example aspects the technology disclosed herein concerns a network node of a telecommunications system. In an example embodiment and mode network node comprises processor circuitry and interface circuitry. The processor circuitry is configured to configure plural resource types for a data flow between the network node and a wireless terminal. The interface circuitry is configured to transmit, over a radio interface to the wireless terminal, a message that identifies the plural resource types for the data flow. Methods of operating such network nodes are also disclosed.

In the first example aspect the technology disclosed herein also concerns a wireless terminal which communicates with a network node through a radio access network. In an example embodiment and mode the wireless terminal comprises interface circuitry and processor circuitry. The interface circuitry is configured to receive from the network node a message that identifies plural resource types for a data flow between the network node and the wireless terminal. The processor circuitry is configured to determine the plural resource types for the data flow from the message and to use the plural resource types for the data flow to communicate with the network node over the data flow. Methods of operating such wireless terminals are also disclosed.

In a second example aspect the technology disclosed herein concerns a network node of a telecommunications system. In an example embodiment and mode network node comprises processor circuitry and interface circuitry. The processor circuitry is configured to configure plural resource types for a data flow between the network node and a wireless terminal; and differing priorities for at least two of the resource types of the data flow. The interface circuitry is configured to transmit, over a radio interface to the wireless terminal, a message that identifies the plural resource types for the data flow and the differing priorities for the at least two of the resource types of the data flow. Methods of operating such network nodes are also disclosed.

In the second example aspect the technology disclosed herein also concerns a wireless terminal which communicates with a network node through a radio access network. In an example embodiment and mode the wireless terminal comprises interface circuitry and processor circuitry. The interface circuitry is configured to receive from the network node a message that identifies plural resource types for a data flow between the network node and the wireless terminal and differing priorities for at least two of the resource types of the data flow. The processor circuitry configured to determine the plural resource types for the data flow and the differing priorities for at least two of the resource types of the data flow from the message; and to use the plural resource types for the data flow and the priority of the at least one resource type of the data flow to communicate with the network node over the data flow. Methods of operating such wireless terminals are also disclosed.

In a third example aspect the technology disclosed herein concerns a network node of a telecommunications system. In an example embodiment and mode network node comprises processor circuitry and interface circuitry. The processor circuitry is configured to dynamically configure a priority for a data flow between the network node and a wireless terminal. The interface circuitry is configured to transmit, over a radio interface to the wireless terminal, a message that includes an identification of the priority of the resource type for the data flow. Methods of operating such network nodes are also disclosed.

In the third example aspect the technology disclosed herein also concerns a wireless terminal which communicates with a network node through a radio access network. In an example embodiment and mode the wireless terminal comprises interface circuitry and processor circuitry. The interface circuitry is configured to receive from the network node a message that includes an identification of a dynamic configuration of a priority for a data flow. The processor circuitry is configured to implement the dynamic configuration of the priority for the data flow to use the data flow to communicate with the network node. Methods of operating such wireless terminals are also disclosed.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a diagrammatic view of overall architecture for a 5G New Radio system.

FIG. 2 is a diagrammatic view depicting a first example of resource waste occasioned by resource separation.

FIG. 3 is a diagrammatic view depicting a second example of resource waste occasioned by resource separation.

FIG. 4 is a diagrammatic view depicting an example assignment or allocation of multiple resource types configured for a UE or MAC entity.

FIG. 5 is a diagrammatic view depicting an example configuration of allowed resource types.

FIG. 6 is a diagrammatic view of a communications system comprising a network node and a wireless terminal and which may operate with established associations between a configuration parameter and a format type for a control element (MAC CE) of a medium access control (MAC) protocol, and which shows depicts certain basic, example, representative acts or steps performed in the communications system in accordance with a first example aspect of the technology disclosed herein

FIG. 7A and FIG. 7B are schematic views which show in more detail example structures and functionalities that may, in respective first and second example embodiments and modes, comprise or be included in the communications network of FIG. 6.

FIG. 8 is a schematic view showing example units or functionalities that may, in an example embodiment and mode, comprise a resource controller of a core network node of FIG. 7A or of a radio access network node of FIG. 7B.

FIG. 9 is a diagrammatic view depicting a first example assignment or allocation of multiple resource types configured for a data flow as well as differing priorities for at least two of the resource types of the data flow.

FIG. 10 is a diagrammatic view depicting a second example assignment or allocation of multiple resource types configured for a data flow as well as differing priorities for at least two of the resource types of the data flow.

FIG. 11 is a diagrammatic view depicting a third example assignment of a resource type in the context of a dynamic grant.

FIG. 12 depicts certain basic, example, representative acts or steps performed in the communications system, e.g., by network node NN and wireless terminal UE, in accordance with the second example aspect of the technology disclosed herein.

FIG. 13A and FIG. 13B are schematic views which show in more detail example structures and functionalities that may, in respective first and second example embodiments and modes, comprise or be included in the communications network of FIG. 12.

FIG. 14 is a schematic view showing example units or functionalities that may, in an example embodiment and mode, comprise a resource controller of a core network node of FIG. 13A or of a radio access network node of FIG. 13B.

FIG. 15 is a diagrammatic view depicting an example signaling flow of LCH priority and resource type configuration between a network node and wireless terminal.

FIG. 16 is a diagrammatic view depicting an example split radio bearer structure in conjunction with the third aspect of the technology disclosed herein and in which logical channel 1 and logical channel 2 are considered as peer logical channels of each other.

FIG. 17 is a diagrammatic view depicting an example medium access control - control element, MAC CE, format which indicates an example of change of logical channel, LCH, priority.

FIG. 18 is a diagrammatic view depicting an example MAC CE format which indicates the change of LCH priority for a resource type.

FIG. 19 is a diagrammatic view depicting an example MAC CE format which indicates a change of LCH priorities for at least one resource type.

FIG. 20 is a diagrammatic view depicting an example signaling flow of a MAC CE indicating change of LCH priority, along with configuration of LCH priority and resource type between the base station and wireless terminal.

FIG. 21 is a diagrammatic view depicting an example MAC CE format which indicates the change of LCH priorities for a radio bearer.

FIG. 22 is a diagrammatic view depicting an example MAC CE format which indicates the change of all LCH priorities for a radio bearer and a resource type.

FIG. 23 depicts certain basic, example, representative acts or steps performed in the communications system, e.g., by network node NN and wireless terminal UE, in accordance with the third example aspect of the technology disclosed herein.

FIG. 24A and FIG. 24B are schematic views which show in more detail example structures and functionalities that may, in respective first and second example embodiments and modes, comprise or be included in the communications network of FIG. 23.

FIG. 25 is a schematic view showing example units or functionalities that may, in an example embodiment and mode, comprise a resource controller of a core network node of FIG. 24A or of a radio access network node of FIG. 24B.

FIG. 26 is a diagrammatic view showing example elements comprising electronic machinery which may comprise a wireless terminal, a radio access node, and a core network node according to an example embodiment and mode.

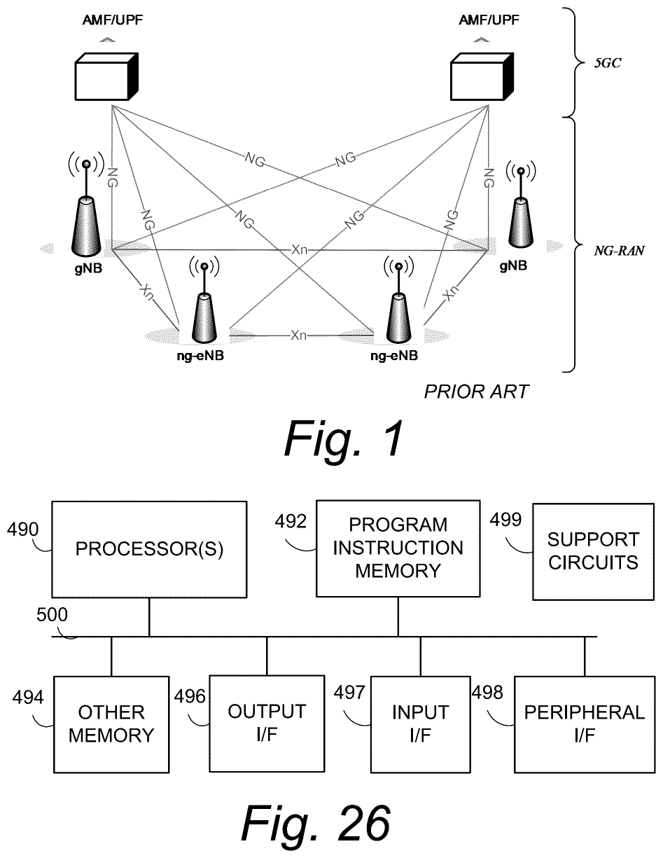

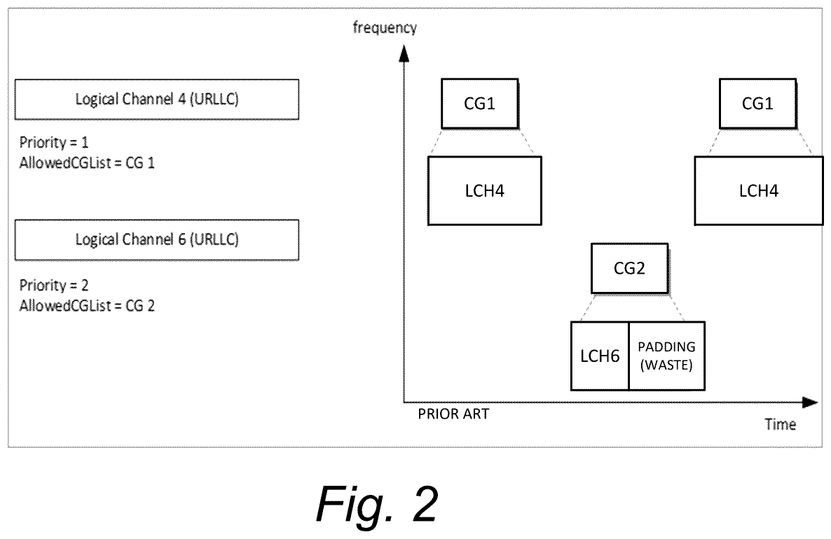

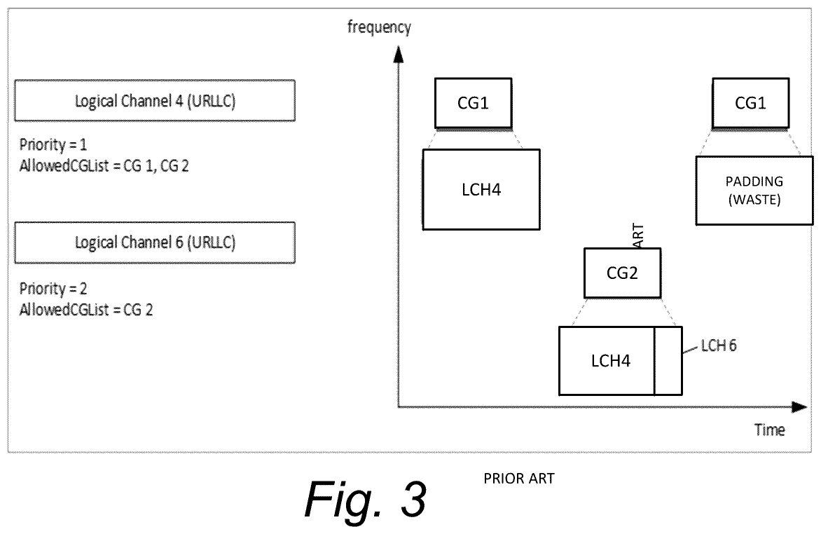

### DETAILED DESCRIPTION

In the following description, for purposes of explanation and not limitation, specific details are set forth such as particular architectures, interfaces, techniques, etc. in order to provide a thorough understanding of the technology disclosed herein. However, it will be apparent to those skilled in the art that the technology disclosed herein may be practiced in other embodiments that depart from these specific details. That is, those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail. All statements herein reciting principles, aspects, and embodiments of the technology disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudo code, and the like represent various processes which may be substantially represented in computer readable medium and so executed by a computer or processor, whether or not such computer or processor is explicitly shown.

As used herein, the term “telecommunication system” or “communications system” can refer to any network of devices used to transmit information. A non-limiting example of a telecommunication system is a cellular network or other wireless communication system. As used herein, the term “cellular network” or “cellular radio access network” can refer to a network distributed over cells, each cell served by at least one fixed-location transceiver, such as a base station. A “cell” may be any communication channel that is specified by standardization or regulatory bodies to be used for International Mobile Telecommunications-Advanced (“IMTAdvanced”); IMT-2020, e.g., 5G; IMT-2030, e.g., 6G, etc. All or a subset of the cell may be adopted by 3GPP as licensed bands (e.g., frequency band) to be used for communication between a base station, such as a Node B, and a UE terminal. A cellular network using licensed frequency bands can include configured cells. Configured cells can include cells of which a UE terminal is aware and in which it is allowed by a base station to transmit or receive information. Examples of cellular radio access networks include E-UTRAN, and any successors thereof (e.g., NUTRAN).

A core network (CN) may comprise numerous servers, routers, and other equipment. As used herein, the term “core network” can refer to a device, group of devices, or sub-system in a telecommunication network that provides services to users of the telecommunications network. Examples of services provided by a core network include aggregation, authentication, call switching, service invocation, gateways to other networks, etc. A core network may communicate over a RAN-CN interface (e.g., N2 interface) with one or more radio access networks (RAN).

A radio access network (RAN) may communicate with one or more core networks. A radio access network (RAN) typically comprises plural access nodes. As used herein, the term “access node”, “node”, or “base station” can refer to any device or group of devices that facilitates wireless communication or otherwise provides an interface between a wireless terminal and a telecommunications system. A non-limiting example of a base station can include, in the 3GPP specification, a Node B (“NB”), an enhanced Node B (“eNB”), a home eNB (“HeNB”), a gNB (for a New Radio [“NR”] technology system), or some other similar terminology.

A radio access network (RAN) 22 serves wireless terminals, which also form part of the radio access network (RAN). As used herein, the term “wireless terminal” can refer to any electronic device used to communicate voice and/or data via a telecommunications system, such as (but not limited to) a cellular network. Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, tablets, netbooks, e-readers, wireless modems, etc.

A wireless terminal communicates with its serving radio access network (RAN) over a radio or air interface. Communication between radio access network (RAN) and wireless terminal over the radio interface occurs by utilization of “resources”. Any reference to a “resource” herein means “radio resource” unless otherwise clear from the context that another meaning is intended. In general, as used herein a radio resource (“resource”) is a time-frequency unit that can carry information across a radio interface, e.g., either signal information or data information.

Communication between radio access network (RAN) 24 and wireless terminal over the radio interface 32 may occur on various layers. Layer 1 includes radio layer 1 or the physical layer. Higher layers, e.g., layers higher than Layer 1 may include radio layer 2 and radio resource control layer 3. The layer 1 communication may occur by utilization of “resources”. Reference to a “resource” herein means “radio resource” unless otherwise clear from the context that another meaning is intended. In general, as used herein a radio resource (“resource”) is a time-frequency unit that can carry information across a radio interface, e.g., either signal information or data information.

An example of a radio resource occurs in the context of a “frame” of information that is typically formatted and prepared, e.g., by a node. In Long Term Evolution (LTE) a frame, which may have both downlink portion(s) and uplink portion(s), is communicated between the base station and the wireless terminal. Each LTE frame may comprise plural subframes. For example, in the time domain, a 10 ms frame consists of ten one millisecond subframes. An LTE subframe is divided into two slots (so that there are thus 20 slots in a frame). The transmitted signal in each slot is described by a resource grid comprised of resource elements (RE). Each column of the two-dimensional grid represents a symbol (e.g., an OFDM symbol on downlink (DL) from node to wireless terminal; an SC-FDMA symbol in an uplink (UL) frame from wireless terminal to node). Each row of the grid represents a subcarrier. A resource element (RE) is the smallest time-frequency unit for downlink transmission in the subframe. That is, one symbol on one sub-carrier in the sub-frame comprises a resource element (RE) which is uniquely defined by an index pair (k,l) in a slot (where k and l are the indices in the frequency and time domain, respectively). In other words, one symbol on one sub-carrier is a resource element (RE). Each symbol comprises a number of sub-carriers in the frequency domain, depending on the channel bandwidth and configuration. The smallest time-frequency resource supported by the standard today is a set of plural subcarriers and plural symbols (e.g., plural resource elements (RE)) and is called a resource block (RB). A resource block may comprise, for example, 84 resource elements, i.e., 12 subcarriers and 7 symbols, in case of normal cyclic prefix

In 5G New Radio (“NR”), a frame consists of 10 ms duration. A frame consists of 10 subframes with each having 1 ms duration similar to LTE. Each subframe consists of 2^{μ} slots. Each slot can have either 14 (normal CP) or 12 (extended CP) OFDM symbols. A Slot is a typical unit for transmission used by scheduling mechanism. NR allows transmission to start at any OFDM symbol and to last only as many symbols as required for communication. This is known as “mini-slot” transmission. This facilitates very low latency for critical data communication as well as minimizes interference to other RF links. Mini-slots help to achieve lower latency in 5G NR architecture. Unlike slots, mini-slots are not tied to the frame structure. It helps in puncturing the existing frame without waiting to be scheduled. See, for example, https: //www.rfwireless-world.com/5G/5G-NR-Mini-Slot.html, which is incorporated herein by reference.

In general, communication protocols between the wireless terminal and the telecommunication system may be categorized into Access Stratum (AS) and Non-Access Stratum (NAS). AS protocols, such as Radio Resource Control (RRC) and Medium Access Control (MAC), may be used for the wireless terminal to communicate with access nodes of a RAN, whereas NAS protocol(s), such as the NAS protocol specified in 3GPP TS 24.501, may be used for the wireless terminal to communicate with entities (e.g., AMF) of a CN(s), via access nodes of a RAN. Consequently, the wireless terminal may comprise a function to manage the AS protocols, and a separate function to manage the NAS protocol(s). Herein, terminology “NAS” may be used in some context to refer to the function built into the wireless terminal to manage the NAS protocol(s). Similarly, “RRC” may be used in some context to refer to the function built into the wireless terminal to manage the RRC protocol.

5G includes two cell group types: Master Cell Group (MSG) and Secondary Cell Group (SCG). The Master Cell Group is a group of serving cells associated with the Master RAN Node, comprising of the SpCell (Special Cell) which is known as the PCell (Primary Cell) and optionally one or more SCell (Secondary Cell). A PCell is used to initiate the initial access and considered as main cell in MCG. The Secondary Cell Group is a group of serving cells associated with the Secondary RAN Node, comprising of the SpCell which is known as the PSCell (Primary SCell) and optionally one or more SCells. UE might be configured with one or more SCell in connected mode. SCell can be activated or deactivated according to traffic.

### Multiple Resource Types for Data Flow

In one of its example aspects, the technology disclosed herein concerns a network node which configures plural resource types for a data flow between the network node and a wireless terminal, and a wireless terminal which uses the plural resource types for the data flow to communicate with the network node over the data flow. A “network node” may be either a node of a core network or a node of a radio access network. As used herein, “wireless terminal” encompasses one or more medium access control, MAC, entities that may comprise or be included in the wireless terminal.

As mentioned above, a “resource” may be conceptualized as a time-frequency unit that can carry information across a radio interface. As used herein, “resource type” refers to a manner in which the resource(s) is categorized or classified or utilized, such as, for example, to which type of cells it is available, e.g., PCell or SCell; the manner in which it may be granted, e.g., dynamic or static; priority on the physical layer.

As used herein, “data flow” generically refers to any manner or technique in which information may be transmitted between the network node and the wireless terminal, including a logical channel, LCH, a quality of service, QoS, or Extended Reality “modality” which may be, e.g., a single stream of voice. In an example embodiment and mode, the network node configures a message which identifies the plural resource types and transmits the message of the plural resource types over a radio interface to the wireless terminal. The message may comprise an identifier for each of the plural resource types, such as an index. Alternatively the message may comprise a grant, e.g., an uplink grant.

Thus, a grant is an example of a resource identifier, e.g., a resource allocation. Two types of grants are referenced herein: a configured grant (CG) and a dynamic grant (DG). A configured grant (CG) CG is a periodic grant, e.g., the same resource size is repeated until deactivation. The periodicity of CG is configured by RRC signaling from gNB to the UE. In a recent version of the NR specification, up to 32 CGs can be configured for a MAC entity. Each logical channel may have its allowed CGs by configuring allowedCG-List. A dynamic grant (DG) is a one-shot grant allocated to the UE. For a DG, gNB sends a DCI on PDCCH which configures the location and other scheduling information related the DG. In DG allocation, “Dynamically configures” means that each DCI configures a one-shot physical layer resource, e.g., time-frequency resource. Based on the DCI information, gNB gives a PUSCH resource to the UE to transmit the uplink data. Once it is used by the UE, UE should keep monitoring PDCCH for the next resource allocation.

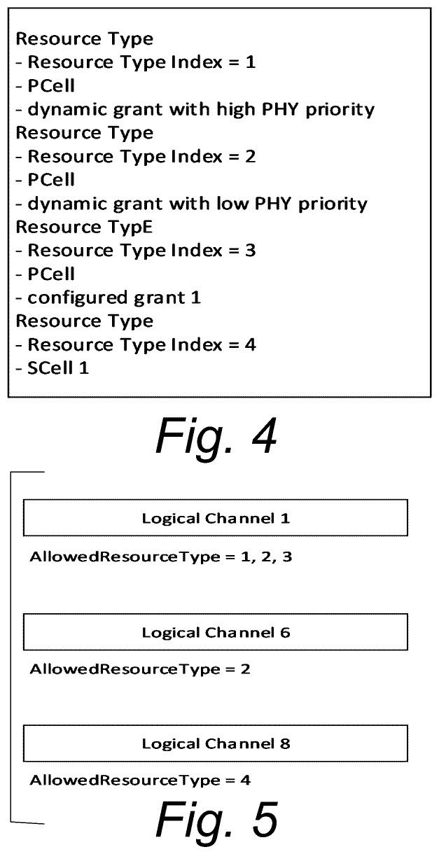

FIG. 4 depicts an example of multiple resource types configured for a UE or MAC entity. The network node, which may be a base station, gNB in 5G NR, provides resource types which a wireless terminal, e.g., UE, may use. The resource type is configured by an RRC message. In FIG. 4, four resource types identified by resource type index are configured. The first resource type with Index=1 is a dynamic grant, e.g., an uplink grant assigned by downlink control information (DCI) on a PDCCH, physical downlink control channel, with high physical layer, PHY, priority on PCell. The second resource type with Index=2 is a dynamic grant with low PHY priority on PCell. The third resource type with Index=3 is a configured grant 1 on PCell. The fourth resource type with Index=4 is any resource on SCell 1. If none of resource types are configured, then the UE interprets that there is no differentiation among resource types and each logical channel may use any types of resources.

Based on resource types configured for a UE, each logical channel may have allowed resource types which the logical channel is allowed to use. FIG. 5 depicts an example configuration of allowed resource types. Instead of multiple LCH mapping restrictions which are complicated, each logical channel may be associated with resource type index of allowed resource type which the logical channel can use. In the example of FIG. 5, three logical channels are illustrated, namely, logical channel 1, logical channel 6, and logical channel 8 are configured. LCH1 may use resource types 1, 2 and 3. LCH 6 may use resource type 2. LCH 8 may use resource type 4. Allowed resource types are configured by an RRC message. The information can be included in each logical channel's configuration, e.g., logicalChannelConfig.

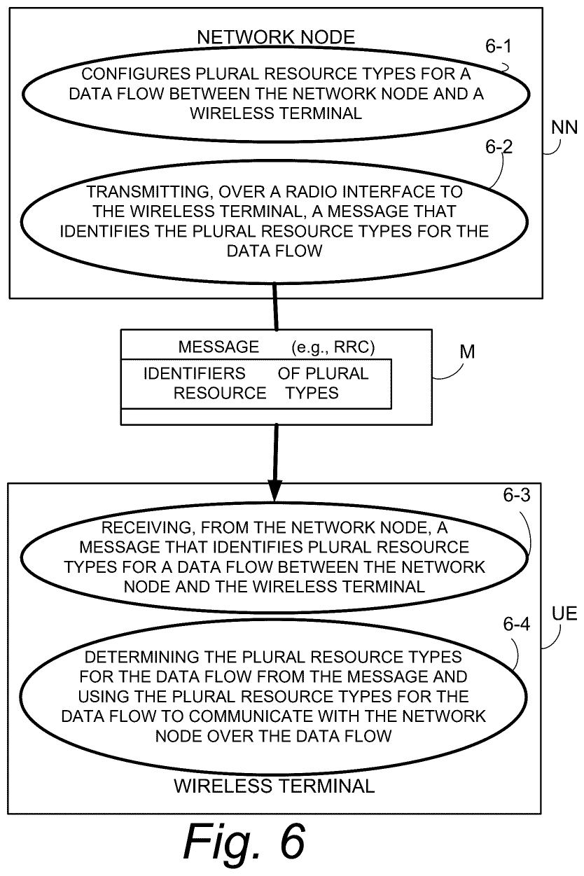

FIG. 6 shows a communications system which comprises a network node NN and a wireless terminal UE. It should be understood that herein “network” may be used interchangeably with “network node”, except where otherwise clear from the context. In the communications system of FIG. 6 the network node NN configures plural resource types for a data flow between the network node and the wireless terminal UE which uses the plural resource types for the data flow to communicate with the network node over the data flow. The network node NN may be either a core network node or a node of a radio access network, such as a RAN access node, e.g., a base station node, for example. The wireless terminal UE may be any electronic device used to communicate voice and/or data via a telecommunications system, such as (but not limited to) a cellular network. Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, tablets, netbooks, e-readers, wireless modems, etc. be any

FIG. 6 depicts certain basic, example, representative acts or steps performed in the communications system, e.g., by network node NN and wireless terminal UE, in accordance with a first example aspect of the technology disclosed herein. Such basic acts are now briefly described with reference to acts 6-1 through and including 6-5 and are understood more fully in the context of the ensuing description.

Act 6-1 comprises the network node NN configuring plural resource types for a data flow between the network node and a wireless terminal. Act 6-2 comprises the network node NN generating and transmitting, over a radio interface to the wireless terminal, a message M that identifies the plural resource types for the data flow.

In an example embodiment and mode, the message M may include an identifier of each of the plural resource types. For example, each identifier may be an index. Thus, in the situation shown in FIG. 4 and FIG. 5, the message may include one or more information elements that include the indices 1, 2, and 3 for the Logical Channel 1 of FIG. 5, those indices having the respective parameters indicated by the example of FIG. 4. Alternatively, the message may include a grant, e.g., an uplink grant.

Act 6-3 comprises the wireless terminal UE receiving, from the network node NN, a message that identifies plural resource types for a data flow between the network node and the wireless terminal. Act 6-4 comprises the wireless terminal UE determining the plural resource types for the data flow from the message and using the plural resource types for the data flow to communicate with the network node over the data flow.

The definitions/descriptions of both the resource types and the indices must be understood and harmonized between the network node NN and the wireless terminal UE. Such definitions or descriptions may be pre-configured at the network node NN and the wireless terminal UE or may be communicated from the network node NN to the wireless terminal UE by any suitable signal or message. The association between resource type and index may be configured by an RRC message (e.g., in message M). A UE capability message is used for the UE to indicate to gNB that this feature is supported by the UE The definitions or descriptions may be known, e.g., stored in memory or a processor circuitry, of both the network node NN and the wireless terminal UE.

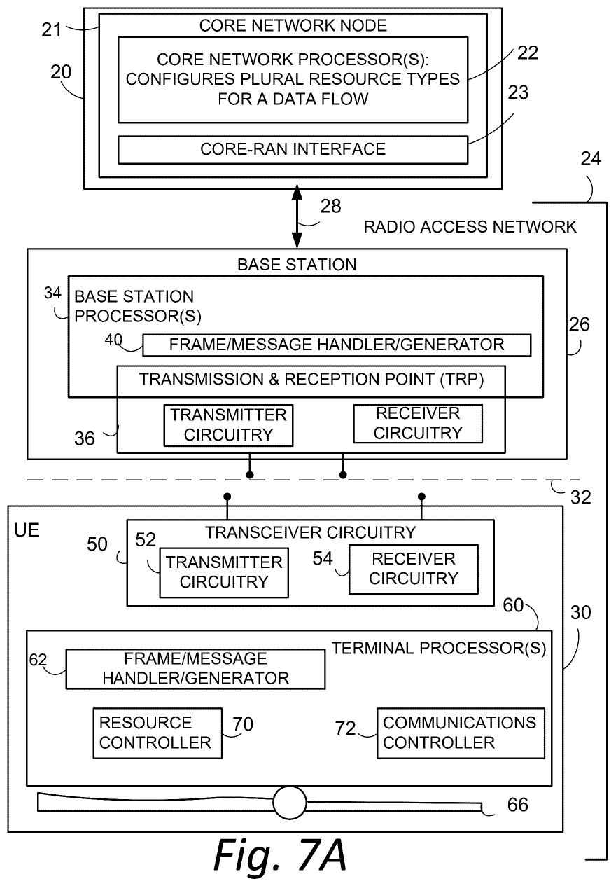

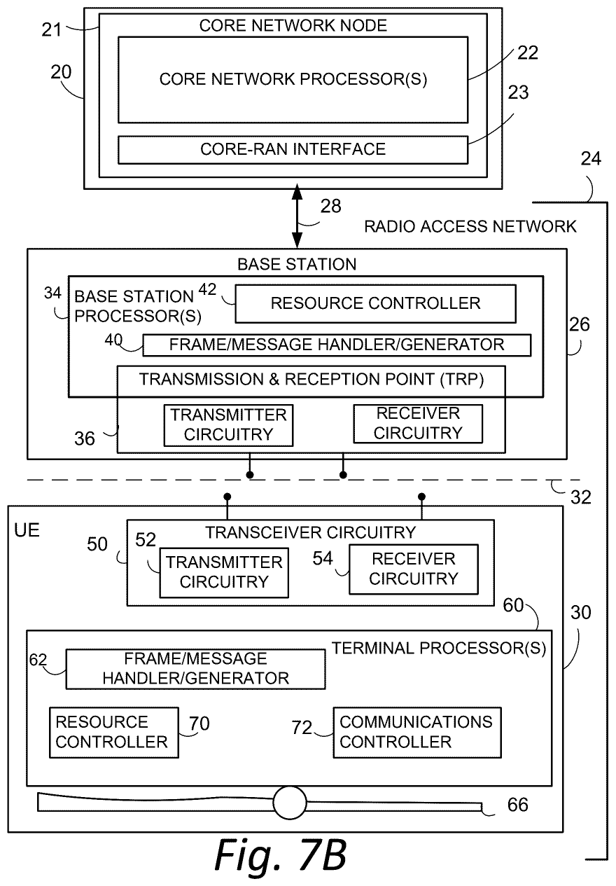

FIG. 7A and FIG. 7B show in more detail example structures and functionalities that may, in respective first and second example embodiments and modes, comprise or be included in the communications network of FIG. 6. In the communications system of FIG. 7A, the network node NN comprises a core network node. By contrast, in the communications system of FIG. 7B, the network node NN comprises a radio access network.

FIG. 7A and FIG. 7B both show that the example communications networks, which may be 5G networks, for example, comprise core network 20. The core network 20 may comprise one or more core network nodes, such as core network node 21. The core network node 21 may comprise or be realized by any suitable type of core network node, such as a core network management entity, e.g., an Access and Mobility Management Function (AMF). One or more of the core network nodes 21 may comprise core node processor circuitry, such as core node processor(s) 22. The core network 20 and one or more of its constituent core network nodes 21 is connected to at least one radio access network 24 through a core-RAN interface circuit 23. The core-RAN interface circuit 23 may be connected to wireline(s) 28.

The radio access network 24 in turn comprises one or more radio access network (RAN) nodes, such as example base station node 26. The base station node 26 serves at least one cell. The radio access network, RAN, 24 typically comprises plural access nodes, one example access node 26 being illustrated as a base station node in FIG. 7A and FIG. 7B.

FIG. 7A and FIG. 7B both show the radio access network 24, and base station node 26 through its cell in particular communicating with wireless terminal 30 across a radio or air interface 32. The base station node 26 may, and usually does, communicate with plural wireless terminals across the air interface 32. Only one wireless terminal 30 is shown for sake of simplicity, it being understood that other wireless terminals may be provided and may operate in similar manner as the wireless terminal 30 herein illustrated.

FIG. 7A and FIG. 7B show base station node 26 as comprising base station processor circuitry which may comprise one or more base station processors 34, as well as base station transceiver circuitry 36. As illustrated in FIG. 7A, the base station transceiver circuitry 36 may be a transmission and reception point (TRP). The transmission and reception point (TRP) 36 may further comprise transmitter circuitry and receiver circuitry. The base station processors 34 may comprise frame/message handler/generator 40 which prepares and generates information including user data and messages, e.g., signaling, for transmission over the radio interface 32, as which also processes information received over the radio interface 32.

The base station node 26 may be structured essentially as shown in FIG. 7A and FIG. 7B or may be a node having architecture such as split architecture comprising a central unit and one or more distributed units that comprise mobile termination (MT). The base station processor(s) may include one or more TRPs.

FIG. 7A and FIG. 7B also show various example constituent components and functionalities of wireless terminal 30. For example, FIG. 7A and FIG. 7B show wireless terminal 30 as comprising terminal transceiver circuitry 50. The transceiver circuitry 50 in turn may comprise terminal transmitter circuitry 52 and terminal receiver circuitry 54. The terminal transceiver circuitry 50 may include antenna(e) for the wireless transmission. Terminal transmitter circuitry 52 may include, e.g., amplifier(s), modulation circuitry and other conventional transmission equipment. Terminal receiver circuitry 54 may comprise, e.g., amplifiers, demodulation circuitry, and other conventional receiver equipment.

FIG. 7A and FIG. 7B further show wireless terminal 30 also comprising wireless terminal processor circuitry, e.g., one or more wireless terminal processor(s) 60. The wireless terminal 30, e.g., wireless terminal processor(s) 60, may comprise terminal frame or message handler/generator 62. The wireless terminal 30 may also comprise user interfaces 66, including one or more user interfaces. Such user interfaces may serve for both user input and output operations, and may comprise (for example) a keyboard, a mouse, a screen such as a touch screen that can both display information to the user and receive information entered by the user. The user interface 66 may also include other types of devices, such as a speaker, a microphone, or a haptic feedback device, for example.

In the example embodiment and mode of FIG. 7A the network node NN which performs acts such as act 6-1 and act 6-2 of FIG. 6 is a core network node, such as core network node 21 of FIG. 7A. FIG. 7A particularly shows the core node processor(s) 22 of core network node 21 which configures plural resource types for a data flow between the network node and a wireless terminal, as described herein. Further, in the example embodiment and mode of FIG. 7A, the core-RAN interface circuit 23 is the interface that, under direction of core node processor(s) 22, transmits the message M which includes the plural resource types for the data flow to the wireless terminal 30. It should be understood that the message M in the example embodiment and mode of FIG. 7A is eventually transmitted to wireless terminal 30 through the radio access network, e.g., in which case the message M may be modified for the protocols utilized in communications between the radio access network and the wireless terminal 30.

In the example embodiment and mode of FIG. 7B the network node NN which performs acts such as act 6-1 and act 6-2 of FIG. 6 is a radio access network node, such as radio access network node 26 of FIG. 7B. FIG. 7B particularly shows that the base station processor(s) 34 of base station node 26 comprise resource controller 42 which serves to configure the plural resource types for a data flow between the network node and a wireless terminal. Further, in the example embodiment and mode of FIG. 7B, the base station transceiver circuitry 36, under direction of base station processor(s) 34, transmits the message M which includes the plural resource types for a data flow to the wireless terminal 30.

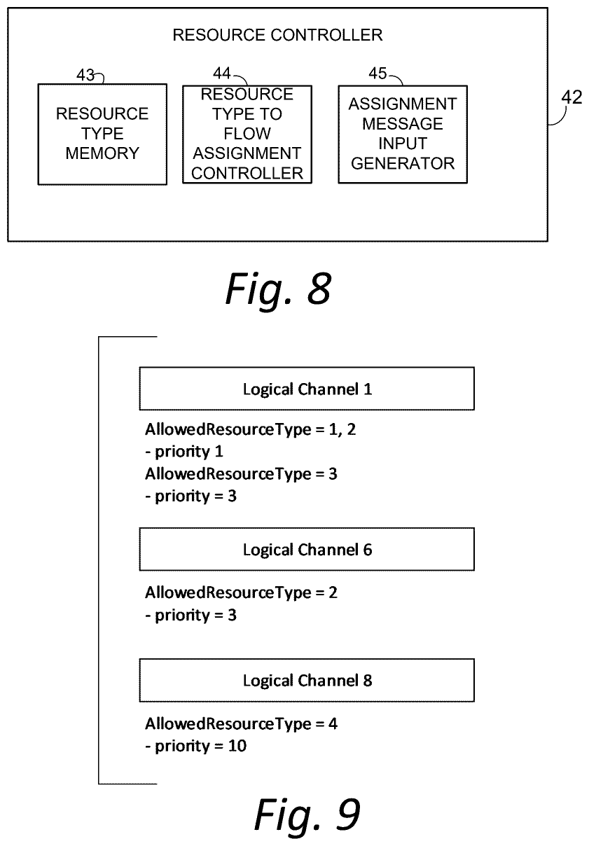

FIG. 8 shows example units or functionalities that may comprise resource controller 42 in an example, non-limiting example embodiment and mode. As shown in FIG. 8 resource controller 42 may comprise resource type memory 43; resource type-to-data flow assignment controller 44; and assignment message input generator 45. The resource type memory 43 preferably stores definitions or descriptions of the resource types and the indices which, as mentioned above, are understood and harmonized between the network node and the wireless terminal. For example, the resource type memory 43 may include information such as that depicted in FIG. 4 for describing the resource types and may further associate an index with the resource type(s). The resource type-to-data flow assignment controller 44 may serve to assign one or more resource types to a data flow. For example, with reference to FIG. 5, the resource type-to-data flow assignment controller 44 may assign one or more resource types, e.g., by index, to one or more data flows. As an example, the resource type-to-data flow assignment controller 44 may assign or confer the resource types associated with indices 1, 2, and 3 to logical channel LCH1, as shown in FIG. 5. Upon completion of the assignments by resource type-to-data flow assignment controller 44, assignment message input generator 45 may generate a message or input to for preparation of a message that will communicate to the wireless terminal 30 which resource types are allocated or assigned to a channel. For example, assignment message input generator 45 may prepare information for a message that indicates that logical channel LCH1 has three resource types following the example of FIG. 5. Thus, assignment message input generator 45 may either prepare the message M, or may prepare information that may be used by frame/message handler/generator 40 to generate the message M. As indicated previously, the message M may be any RRC message. RRC signaling for message M may any appropriate radio resource control (RRC) signal, such as RRCSetup, RRCReconfiguration, RRCResume or RRCRelease message. The message M may comprise one or more information elements that specify the resource types assigned to a data flow, e.g., to a logical channel.

Although the example resource controller 42 of FIG. 8 has been discussed primarily with reference to a radio access network node, it should be understood that similar units and functionalities may also be included in an example embodiment and mode in which the core node processor(s) 22 function as the resource controller.

The wireless terminal 30 of both FIG. 7A and FIG. 7B may perform the acts 6-3 through and including 6-4 of FIG. 6. In particular the wireless terminal processor(s) 60 may be involved in performing act 6-4. The wireless terminal processor(s) 60 are configured to perform many functions for operation of the wireless terminal in general, as known to the person skilled in the art. For performing functions germane to the technology disclosed herein, in an example embodiment and mode the wireless terminal processor(s) 60 may be structured or configured to comprise or realize several functionalities or units including resource controller 70 and communications controller 72. The resource controller 70 serves, e.g., to apply the received resource assignments to the data flows. The communications controller 72 serves, e.g., to generate and process information included in the data flows.

As mentioned above, the second problem described above which is associated with current LCH mapping restriction has a limitation that some mapping restrictions cannot be configured due to the nature of jointly applied restrictions. To resolve the limitation, this the technology disclosed herein and described with reference to, e.g., FIG. 6, FIG. 7A, and FIG. 7B, proposes a concept of resource type and multiple resource types can be configured for a UE. Also, for each data flow, LCH in 5G, multiple allowed resource types can be configured to use. The technology disclosed herein thus advantageously provides one or more of the following:
Multiple resource types can be configured for a UE.
Resource type index is defined as its identifier.
Resource type is defined as uplink grant which satisfies all conditions of the resource type.
For each data flow (either logical channel (LCH) or QoS flow (QF) or other flow), allowed resource type is configured.
Multiple allowed resource types can be configured for each data flow (either LCH or QF)
Configuration communicated by an RRC signaling from the base station to the UE
For a dynamic grant, physical layer control signaling (DCI: Downlink Control Information) can indicate the resource type index of the uplink grant allocated by the DCI.

Resource Types with Different Priorities for Data Flow

In a second of its example aspects, the technology disclosed herein concerns a network node which not only configures plural resource types for a data flow between the network node and a wireless terminal, but also configures differing priorities for at least two of the resource types of the data flow. In this example aspect, the wireless terminal uses the plural resource types for the data flow and the differing priorities for the at least two of the resource types of the data flow to communicate with the network node over the data flow. Definitions and explanation from the previous aspect example embodiment and mode are applicable to this aspect as well unless otherwise evident from the context.

FIG. 9 depicts another exemplary configuration of allowed resource type. In the example of FIG. 9, each data flow, e.g., logical channel, is configured with its allowed resource type. In addition, a data flow priority, e.g., logical channel priority, is configured for at least two resource types. As shown in FIG. 9, and in accordance with the second example aspect of the technology disclosed herein, the logical channel priority may be different for different resource types. The non-limiting example of FIG. 9 shows that three logical channels, namely, logical channel 1, logical channel 6, and logical channel 8 are configured. LCH1 may use resource types 1, 2 and 3. LCH 6 may use resource type 2. LCH 8 may use resource type 4. LCH 1's logical channel priority is changed according to the resource type. For resource type 1 and resource type 2, the priority of LCH 1 is 1 whereas for resource type 3, the priority of LCH 1 is 3. In the example of FIG. 9, LCH1 has multiple priorities depending on resource type. Thus, FIG. 9 illustrates with reference to LCH 1 an example assignment of differing priorities for at least two of the resource types of the data flow. LCH 6 and LCH 8 have a single priority value. Allowed resource types and LCH priority for each resource type may be configured by an RRC message. The information may be included in each logical channel's configuration, e.g., in an information element such as logicalChannelConfig, for example

In some exemplary embodiments, a default LCH priority can be configured for each logical channel. The default LCH priority value is used when the logical channel priority for resource type is not configured. The default LCH priority value can be configured by an RRC message from the base station (gNB) to the UE.

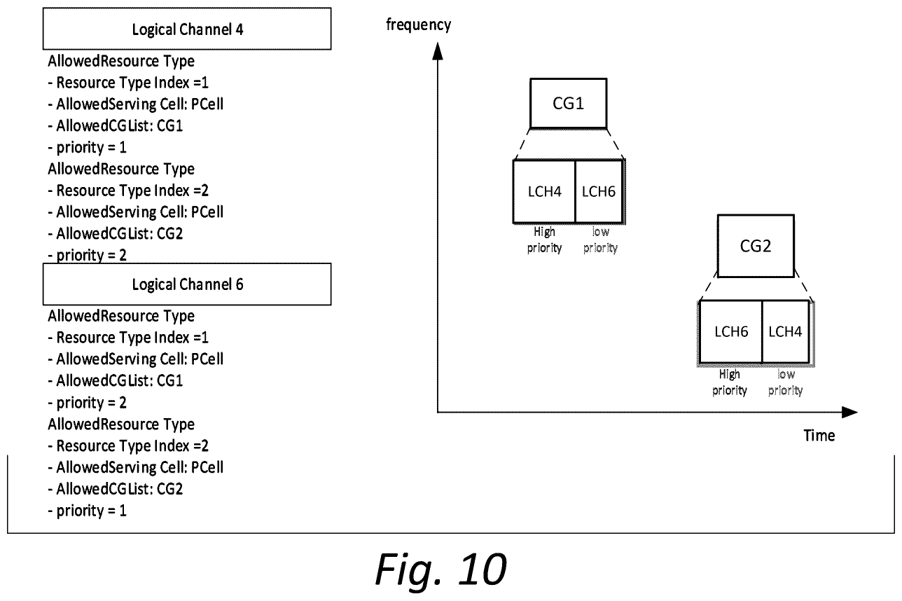

FIG. 10 shows two different periodic resources with different configurations, e.g., periodic grant CG1 and periodic grant CG2. Each of CG1 and CG2 is separately configured with a CG index configured in an information element CG-Config of a RRC reconfiguration message. In FIG. 10, CG1 is assumed to be a periodic resource with index “1”, while CG2 is assumed to be a periodic resource with index “2”. Accordingly, FIG. 10 depicts another exemplary configuration of multiple resource types and priority for each resource type. In FIG. 10, two logical channels, namely, LCH 4 and LCH 6 are configured. LCH 4 has two allowed resource types. The first allowed resource type for LCH 4 is CG1 on PCell, and the priority of LCH 4 on this resource type is 1. The second allowed resource type for LCH 4 is CG2 on PCell, and the priority of LCH 4 on this resource type is 2. LCH 6 has two allowed resource types. The first allowed resource type for LCH 6 is CG1 on PCell, and the priority of LCH 6 on this resource type is 2. The second allowed resource type for LCH 6 is CG2 on PCell, and the priority of LCH 6 on this resource type is 1. For CG1 on PCell, LCH4 has higher priority than LCH6 whereas LCH6 has higher priority than LCH4 for CG2.

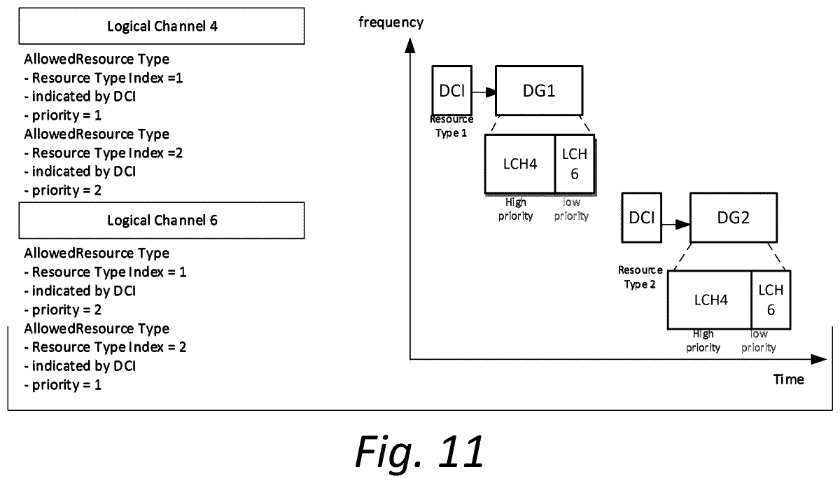

FIG. 11 depicts an exemplary configuration of multiple resource types indicated by downlink control information, DCI, on a physical downlink control channel, PDCCH, and priority for each resource type. As indicated previously, a dynamic grant is a one-shot resource indicated by DCI. DCI contains relevant information on the dynamic grant. The DCI used for a dynamic grant may contain the resource type index which indicates the resource type. Based on the resource type index, the logical channel priority of each logical channel is determined, e.g., in the manner of FIG. 4, for example. If the indicated resource type index is an index for resource type which is not allowed for the logical channel, the logical channel cannot participate in Logical Channel Prioritization (LCP). More specifically, the logical channel cannot send any data via the uplink grant.

In the example of FIG. 11, two logical channels, namely, LCH 4 and LCH 6 are configured. LCH 4 has two allowed resource types. The first allowed resource type is described by a dynamic grant indicated by DCI and its LCH priority is 1. The second allowed resource type is described by a dynamic grant indicated by DCI and its LCH priority is 2. LCH 6 has two allowed resource types. The first allowed resource type is dynamic grant indicated by DCI and its LCH priority is 2. The second allowed resource type is dynamic grant indicated by DCI and its LCH priority is 1.

After the initial configuration of the resource types, one or more DCI may be transmitted which indicates a subsequent dynamic grant allocation and its resource type. In FIG. 11, the first DCI indicates that the resource type of the first dynamic grant (DG1) is resource type 1. Then, upon implementation of the first dynamic grant (DG1), LCH 4 with priority 1 and LCH6 with priority 2 participate in LCP. For DG1, LCH 4 has higher priority than LCH 6. Later, another DCI indicates a second dynamic grant (DG2) allocation and its resource type. The second DCI indicates that the resource type of the second dynamic grant (DG2) is resource type 2. Then, upon implementation of the second dynamic grant (DG2), LCH 4 with priority 2 and LCH 6 with priority 1 participate in LCP. For DG2, LCH 6 has higher priority than LCH 4.

In the second aspect of the technology disclosed herein, the allowed resource type and its LCH priority may be configured by an RRC signaling from the base station to the UE.

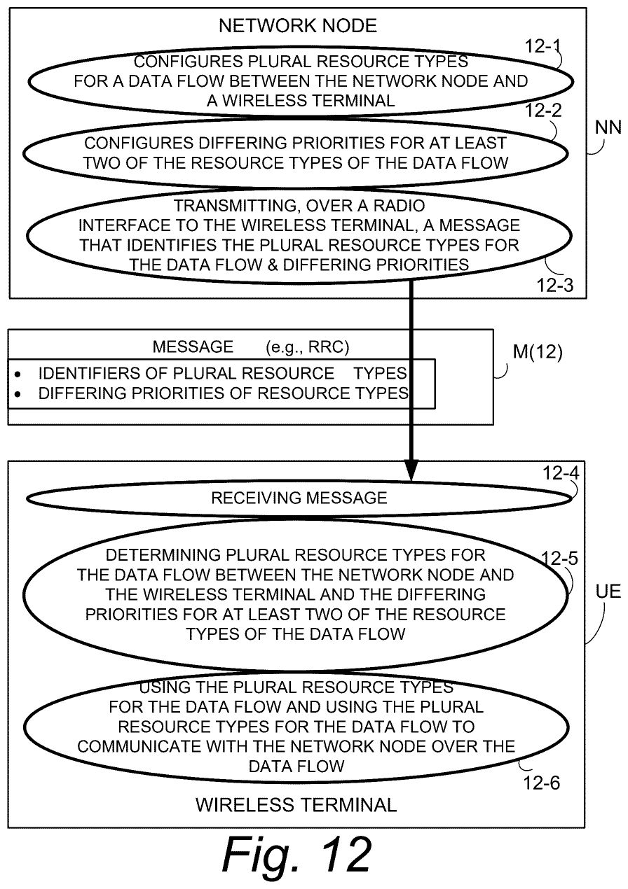

FIG. 12 depicts certain basic, example, representative acts or steps performed in the communications system, e.g., by network node NN and wireless terminal UE, in accordance with the second example aspect of the technology disclosed herein. Such basic acts are now briefly described with reference to acts 12-1 through and including 12-5 and are understood more fully in the context of the ensuing description.

Act 12-1 comprises the network node NN configuring plural resource types for a data flow between the network node and a wireless terminal. Act 12-1 comprises the network node NN configuring differing priorities for at least two of the resource types of the data flow. Act 12-3 comprises the network node NN generating and transmitting, over a radio interface to the wireless terminal, a message M(12) that identifies the plural resource types for the data flow and the differing priorities for the at least two of the resource types of the data flow. As used herein, the message M(12) may comprise at least one message, and thus may comprise plural messages to convey the information configured by the network node NN.

Act 12-4 comprises the wireless terminal UE receiving, from the network node NN, a message(s), e.g., one or more messages, that identifies plural resource types for a data flow between the network node and the wireless terminal and the differing priorities for at least two of the resource types of the data flow. Act 12-5 comprises the wireless terminal UE determining the plural resource types for the data flow and the differing priorities for at least two of the resource types of the data flow from the message. Act 12-6 comprise the wireless terminal UE using the plural resource types for the data flow and the differing priorities for at least two of the resource types of the data flow to communicate with the network node over the data flow.

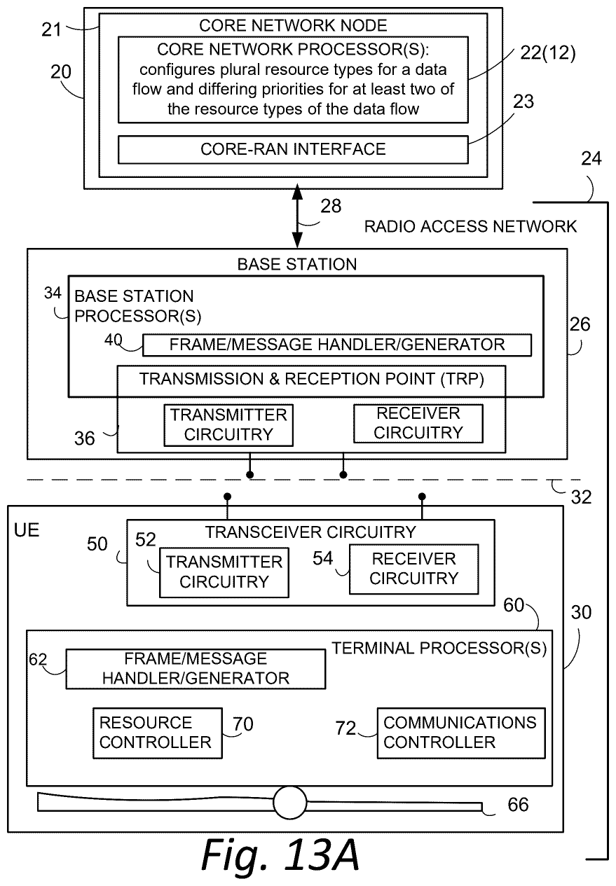

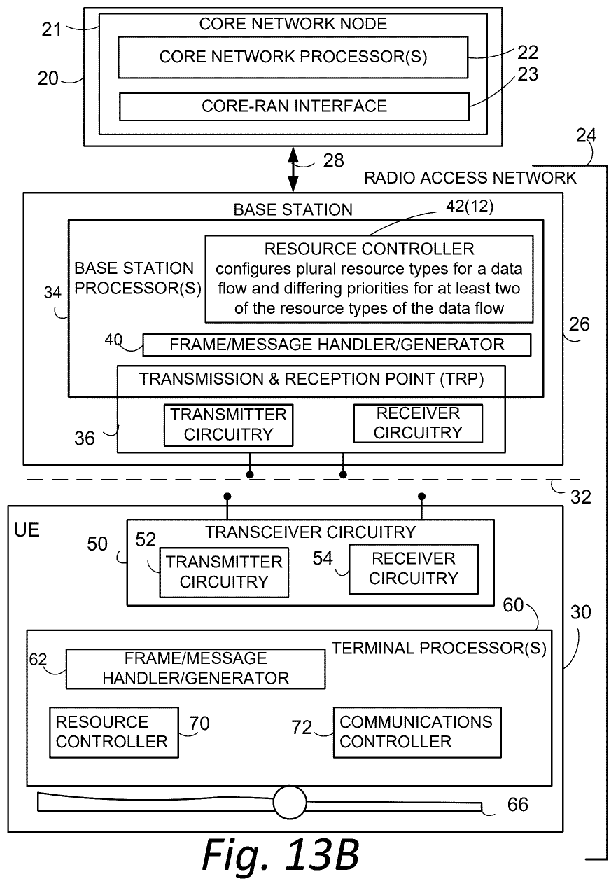

FIG. 13A and FIG. 13B show in more detail example structures and functionalities that may, in respective first and second example embodiments and modes, comprise or be included in the communications network of FIG. 12. In the communications system of FIG. 13A, the network node NN comprises a core network node. By contrast, in the communications system of FIG. 13B, the network node NN comprises a radio access network.

FIG. 13A and FIG. 13B both show that the example communications networks, which may be 5G networks, for example, comprise core network 20. The core network 20 may comprise one or more core network nodes, such as core network node 21. The core network node 21 may comprise or be realized by any suitable type of core network node, such as a core network management entity, e.g., an Access and Mobility Management Function (AMF). One or more of the core network nodes 21 may comprise core node processor circuitry, such as core node processor(s) 22(12). The core network 20 and one or more of its constituent core network nodes 21 is connected to at least one radio access network 24 through a core-RAN interface circuit 23. The core-RAN interface circuit 23 may be connected to wireline(s) 28.

The radio access network 24 in turn comprises one or more radio access network (RAN) nodes, such as example base station node 26. The base station node 26 serves at least one cell. The radio access network, RAN, 24 typically comprises plural access nodes, one example access node 26 being illustrated as a base station node in FIG. 13A and FIG. 13B.

FIG. 13A and FIG. 13B both show the radio access network 24, and base station node 26 through its cell in particular communicating with wireless terminal 30 across a radio or air interface 32. The base station node 26 may, and usually does, communicate with plural wireless terminals across the air interface 32. Only one wireless terminal 30 is shown for sake of simplicity, it being understood that other wireless terminals may be provided and may operate in similar manner as the wireless terminal 30 herein illustrated.

FIG. 13A and FIG. 13B show base station node 26 as comprising base station processor circuitry which may comprise one or more base station processors 34, as well as base station transceiver circuitry 36. As illustrated in FIG. 13A, the base station transceiver circuitry 36 may be a transmission and reception point (TRP). The transmission and reception point (TRP) 36 may further comprise transmitter circuitry and receiver circuitry. The base station processors 34 may comprise frame/message handler/generator 40 which prepares and generates information including user data and messages, e.g., signaling, for transmission over the radio interface 32, as which also processes information received over the radio interface 32.

The base station node 26 may be structured essentially as shown in FIG. 13A and FIG. 13B or may be a node having architecture such as split architecture comprising a central unit and one or more distributed units that comprise mobile termination (MT). The base station processor(s) may include one or more TRPs.

FIG. 13A and FIG. 13B also show various example constituent components and functionalities of wireless terminal 30. For example, FIG. 13A and FIG. 13B show wireless terminal 30 as comprising terminal transceiver circuitry 50. The transceiver circuitry 50 in turn may comprise terminal transmitter circuitry 52 and terminal receiver circuitry 54. The terminal transceiver circuitry 50 may include antenna(e) for the wireless transmission. Terminal transmitter circuitry 52 may include, e.g., amplifier(s), modulation circuitry and other conventional transmission equipment. Terminal receiver circuitry 54 may comprise, e.g., amplifiers, demodulation circuitry, and other conventional receiver equipment.

FIG. 13A and FIG. 13B further show wireless terminal 30 also comprising wireless terminal processor circuitry, e.g., one or more wireless terminal processor(s) 60. The wireless terminal 30, e.g., wireless terminal processor(s) 60, may comprise terminal frame or message handler/generator 62. The wireless terminal 30 may also comprise user interfaces 66, including one or more user interfaces. Such user interfaces may serve for both user input and output operations, and may comprise (for example) a keyboard, a mouse, a screen such as a touch screen that can both display information to the user and receive information entered by the user. The user interface 66 may also include other types of devices, such as a speaker, a microphone, or a haptic feedback device, for example.

In the example embodiment and mode of FIG. 13A the network node NN which performs acts such as act 12-1 through and including act 12-3 of FIG. 12 is a core network node, such as core network node 21 of FIG. 13A. FIG. 13A particularly shows the core node processor(s) 22(12) of core network node 21 which both configures plural resource types for a data flow between the network node and a wireless terminal and configures differing priorities for at least two of the resource types of the data flow, as described herein. Further, in the example embodiment and mode of FIG. 13A, the core-RAN interface circuit 23 is the interface that, under direction of core node processor(s) 22, transmits the message(s) M(12) which includes the plural resource types for the data flow and the differing priorities for at least two of the resource types of the data flow to the wireless terminal 30. It should be understood that the message M(12) in the example embodiment and mode of FIG. 7A is eventually transmitted to wireless terminal 30 through the radio access network, e.g., in which case the message M(12) may be modified for the protocols utilized in communications between the radio access network and the wireless terminal 30.

In the example embodiment and mode of FIG. 13B the network node NN which performs acts such as act 12-1 through and including act 12-3 of FIG. 12 is a radio access network node, such as radio access network node 26 of FIG. 13B. FIG. 13B particularly shows that the base station processor(s) 34 of base station node 26 comprise resource controller 42(12) which serves to configure the plural resource types for a data flow between the network node and a wireless terminal and also to configure the differing priorities for at least two of the resource types of the data flow to the wireless terminal 30. Further, in the example embodiment and mode of FIG. 13B, the base station transceiver circuitry 36, under direction of base station processor(s) 34, transmits the message(s) M(12) which includes the plural resource types for a data flow and the differing priorities for at least two of the resource types of the data flow to the wireless terminal 30.

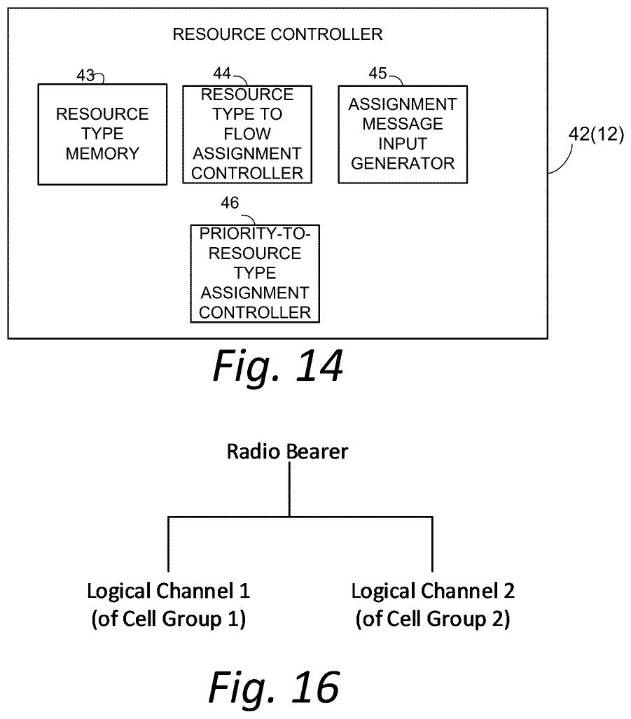

FIG. 14 shows example units or functionalities that may comprise resource controller 42(12) in an example, non-limiting example embodiment and mode. As shown in FIG. 14, resource controller 42(12) may comprise resource type memory 43; resource type-to-data flow assignment controller 44; and assignment message input generator 45, each of which are described in conjunction with the first aspect of the technology disclosed herein. In addition, resource controller 42(12) may comprise priority-to-resource type assignment controller 46. The priority-to-resource type assignment controller 46 may assign the differing priorities for at least two of the resource types of the data flow to the wireless terminal 30. Upon completion of the assignments by resource type-to-data flow assignment controller 44 and priority-to-resource type assignment controller 46, assignment message input generator 45 may generate a message or input to for preparation of a message that will communicate to the wireless terminal 30 which resource types are allocated or assigned to a channel, and the differing priorities for at least two of the resource types of the data flow. As indicated previously, assignment message input generator 45 may either prepare the message M(12), or may prepare information that may be used by frame/message handler/generator 40 to generate the message M. As indicated previously, the message M may be any RRC message. RRC signaling for message M may any appropriate radio resource control (RRC) signal, such as RRCSetup, RRCReconfiguration, RRCResume or RRCRelease message. The message M(12) may comprise one or more information elements that specify the resource types assigned to a data flow, e.g., to a logical channel and the differing priorities for at least two of the resource types of the data flow.

Although the example resource controller 42(12) of FIG. 14 has been discussed primarily with reference to a radio access network node, it should be understood that similar units and functionalities may also be included in an example embodiment and mode in which the core node processor(s) 22(12) function as the resource controller.

The wireless terminal 30 of both FIG. 13A and FIG. 13B may perform the acts 12-4 through and including 12-6 of FIG. 12. In particular the wireless terminal processor(s) 60 may be involved in performing act 12-5 and act 12-6, for example. The wireless terminal processor(s) 60 are configured to perform many functions for operation of the wireless terminal in general, as known to the person skilled in the art. For performing functions germane to the technology disclosed herein, in an example embodiment and mode the wireless terminal processor(s) 60 may be structured or configured to comprise or realize several functionalities or units including resource controller 70 and communications controller 72. The resource controller 70 serves, e.g., to apply the received resource assignments to the data flows and the differing priorities for at least two of the resource types of the data flow. The communications controller 72 serves, e.g., to generate and process information included in the data flows.

As mentioned above, the first problem described above which is associated with current LCH mapping restriction has a limitation that a single LCH priority for all types of resources. In the second aspect of the technology disclosed herein different data flows (LCH or QF) may have different priority values depending on resource type. For example, the priority of data flow (LCH priority in 5G (or 6G if the same concept is used) or QF priority (if QF is visible in MAC) depends on the resource type. The association between priority of data flow and resource type is configured the base station to the UE and may be configured by an RRC signaling from the base station to the UE.

### Dynamic Change of Priority for Data Flow

The examples of FIG. 9, FIG. 10, and FIG. 11 show that, in accordance with the second aspect of the technology disclosed herein, different LCH priorities for different resource types make a scenario that a logical channel is prioritized for some resource types whereas the logical channel can be de-prioritized for other resource types.

In a third of its example aspects, the technology disclosed herein concerns a network node which dynamically configures a priority for a data flow between the network node and a wireless terminal transmits, over a radio interface to the wireless terminal, a message that includes an identification of the dynamic configuration of the priority for the data flow. The third aspect also concerns a wireless terminal which receives from the network node the message that includes an identification of a dynamic configuration of a priority for a data flow and which implements the dynamic configuration of the priority for the data flow to use the data flow to communicate with the network node. Definitions and explanations from the previous aspects and example embodiments and modes are applicable to this third aspect as well unless otherwise evident from the context.

In the third aspect of the technology disclosed herein the allowed resource type and its LCH priority may be configured by RRC signaling from the base station to the UE.

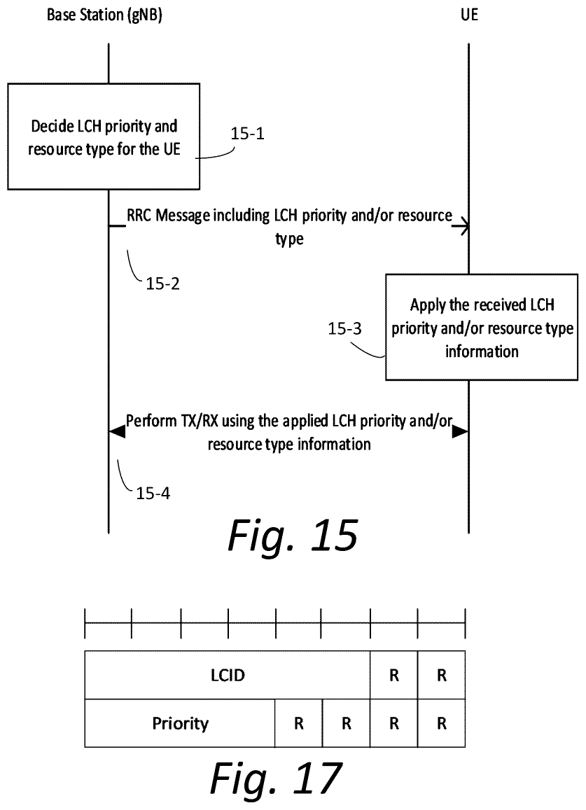

depicts an exemplary signaling flow of LCH priority and resource type configuration between a network node, such as a base station, and a wireless terminal, UE. Act 15-1 shows the network node, e.g., such as a base station as shown in FIG. 15, deciding to provide/configure/change at least one of the resource types for the UE, allowed resource type for each LCH, and LCH priority. As act 15-2 an RRC message is sent from the network to the UE which includes the provided/configured/changed information. The RRC message may be either RRCSetup, RRCReconfiguration, RRCResume or RRCRelease message. As act 15-3 the UE applies the configuration including at least one of LCH priority, resource type for a UE or a MAC entity and allowed resource type for each logical channel after the UE receives the configuration. After the UE applies the configuration at act 15-3, both the network and UE perform transmissions and/or reception based on the received configuration including one of LCH priority, resource type for a UE or MAC entity and allowed resource type for each logical channel, as depicted by act 15-4.

FIG. 16 depicts an exemplary split radio bearer structure. In dual-connectivity configured with two cell groups, which may correspond to two MAC entities, or multi-connectivity configured with more than two cell groups, which may corresponding to more than two MAC entities, a radio bearer can be associated with multiple logical channels associated with multiple cell groups, e.g., corresponding to multiple MAC entities. In such scenario, each logical channel is configured to and under the corresponding MAC entity. Each logical channel may have its own LCH priority by considering QoS requirements and the corresponding MAC entity's scheduling policies. FIG. 16 illustrates an example situation in which logical channel 1 and logical channel 2 are considered as peer logical channels of each other.

The network may need to change one priority value to another one, by considering whether each QoS flow of a logical channel meets its QoS requirement and/or QoS status, e.g. data rate, delay, etc. If the network wants to change LCH priority for a UE, a Medium Access Control—Control Element, MAC CE, can be used to indicate the change. MAC CE is an efficient way to deliver small control information.

FIG. 17 depicts a MAC CE format which indicates an example of change of LCH priority. The MAC CE of FIG. 17 comprises a logical channel identity, LCID, field which identifies the corresponding logical channel and a priority field which indicates the priority value which the corresponding logical channel shall apply. The R field is a reserved bit to have octet (8-bit) alignments. The size of the MAC CE is 2 bytes (16 bits), so it is a fixed-size MAC CE. The sizes of LCID field and priority field are assumed to be 6 bits and 4 bits, respectively. However, different exemplary embodiments may have different sizes.

In the example embodiment of FIG. 17, LCID is assumed to be used as an identity of data flow. However, in another exemplary embodiment, QoS flow ID (QFI) can be used as the identity of the data flow. In this case, the priority value indicates the priority of the QoS flow and QFI field may replace LCID field.

In the case of split bearer depicted in FIG. 16, multiple logical channels belonging to the same radio bearer may need to guarantee the same QoS requirements. If a UE receives a MAC CE indicating change of LCH priority, its peer logical channel of the same radio bearer may need to change its logical channel priority. For instance, when LCH priority of LCH 1 in FIG. 16 is changed by the MAC CE, it may be necessary to change the LCH priority of LCH 2. The LCH priorities of all logical channels for the same radio bearer will have the same value indicated by the MAC CE.

The change of LCH priority of the peer LCH triggered by the MAC CE can be configured by an RRC message. If the change of LCH priority of the peer LCH is configured by an RRC message, the UE or UE's MAC entity applies the change of LCH priority of the peer LCH when an LCH priority is changed.

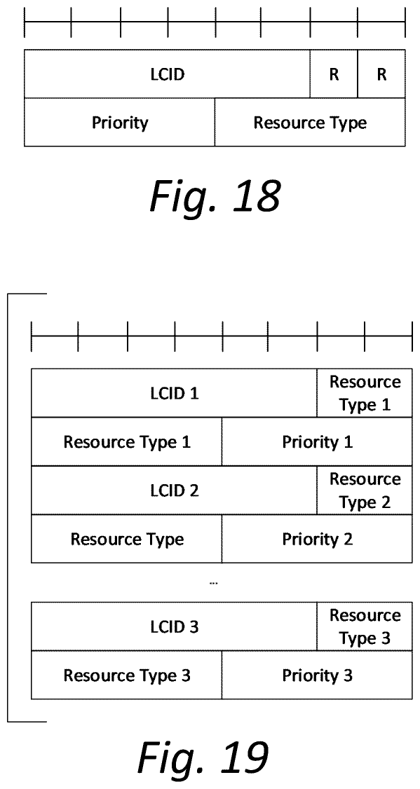

If different resource types have different priority values, a MAC CE may indicate the change of LCH priority for a particular resource type. FIG. 18 depicts a MAC CE format which indicates the change of LCH priority for a resource type. The MAC CE of FIG. 18 comprises a logical channel identity, LCID, field which identifies the corresponding logical channel, a resource type field which indicates the corresponding resource type index, and a priority field which indicates the priority value which the corresponding logical channel shall apply. The R field is a reserved bit to have octet (8-bit) alignments. The size of the MAC CE is 2 bytes (16 bits), so it is a fixed-size MAC CE. The sizes of LCID field, resource type field and priority field are assumed to be 6 bits, 4 bits and 4 bits, respectively. However, different exemplary embodiments may have different sizes.

In the example embodiment of FIG. 18, LCID is assumed to be used as an identity of data flow. However, in another exemplary embodiment, QoS flow ID (QFI) can be used. In this case, the priority value indicates the priority of the QoS flow and QFI field may replace LCID field.

In the example case of a split bearer depicted in FIG. 16, multiple logical channels belonging to the same radio bearer may need to guarantee the same QoS requirements. If a UE receives a MAC CE indicating change of LCH priority for a resource type, its peer logical channel of the same radio bearer may need to change its logical channel priority for the corresponding resource type with the same resource type index. For instance, when LCH priority of LCH 1 for a resource type in FIG. 16 is changed by the MAC CE, it may be necessary to change the LCH priority of LCH 2 for the resource type with the same resource type index. The LCH priorities of all logical channels for the same radio bearer and the same resource type index will have the same value indicated by the MAC CE.

The change of LCH priority of the peer LCH triggered by the MAC CE can be configured by an RRC message. If the change of LCH priority of the peer LCH is configured by an RRC message, the UE or UE's MAC entity applies the change of LCH priority of the peer LCH for the resource type with the same resource type index when an LCH priority for a resource type is changed.

The network may need to change LCH priority values for multiple resource types and/or multiple logical channels. For this case, a single MAC CE may contain priority values for multiple resource types and/or multiple logical channels. FIG. 19 depicts an example MAC CE format which indicates the change of LCH priorities for at least one resource type. The MAC CE of FIG. 19 comprises at least one set of logical channel identity, LCID, field which identifies the corresponding logical channel, a resource type field which indicates the corresponding resource type index, and a priority field which indicates the priority value which the corresponding logical channel shall apply. The MAC CE of FIG. 19 may also comprise at least one R field which is a reserved bit to have octet (8-bit) alignments. The example format of FIG. 19 does not have any R field, as the format is octet aligned and no R field is necessary. If the network wants to change priority values of multiple resource types, the MAC CE may contain multiple sets of LCID field, resource type field and priority field. The size of the MAC CE depends on the number of sets of LCID field, resource type field and priority field included in the MAC CE, so it is a variable-size MAC CE. The sizes of LCID field, resource type field and priority field are assumed to be 6 bits, 6 bits and 4 bits, respectively. However, different exemplary embodiments may have different sizes.

In the example embodiment of FIG. 19, LCID is assumed to be used as an identity of data flow. However, in another exemplary embodiment, QoS flow ID (QFI) can be used. In this case, the priority value indicates the priority of the QoS flow and QFI field may replace LCID field.

In the case of split bearer depicted in FIG. 16, multiple logical channels belonging to the same radio bearer may need to guarantee the same QoS requirements. If a UE receives a MAC CE indicating change of LCH priority for a resource type, its peer logical channel of the same radio bearer may need to change its logical channel priority for the corresponding resource type with the same resource type index. For instance, when LCH priority of LCH 1 for a resource type in FIG. 16 is changed by the MAC CE, it may be necessary to change the LCH priority of LCH 2 for the resource type with the same resource type index. The LCH priorities of all logical channels for the same radio bearer and the same resource type index will have the same value indicated by the MAC CE.

The change of LCH priority of the peer LCH triggered by the MAC CE may be configured by an RRC message. If the change of LCH priority of the peer LCH is configured by an RRC message, the UE or UE's MAC entity applies the change of LCH priority of the peer LCH for the resource type with the same resource type index when an LCH priority for a resource type is changed.

The examples of FIG. 17, FIG. 18, and FIG. 19 show that LCH priority for each logical channel and/or resource type is dynamically changed by a MAC CE.

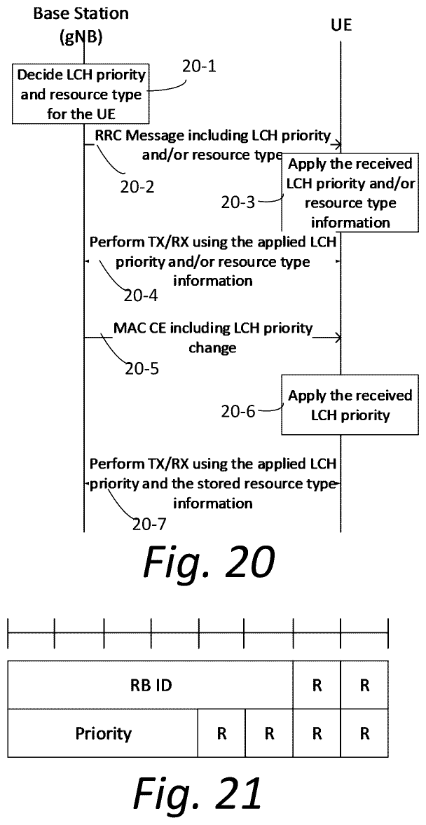

FIG. 20 depicts an exemplary signaling flow of MAC CE indicating change of LCH priority, along with configuration of LCH priority and resource type between the base station and UE. When, as act 20-1, the network node, illustrated as a base station in FIG. 20, decides to provide/configure/change at least one of the resource type for the UE, allowed resource type for each LCH, and LCH priority, an RRC message is sent as act 20-2 from the network to the UE. The RRC message may be either RRCSetup, RRCReconfiguration, RRCResume or RRCRelease message. Act 20-3 comprises the UE applying the configuration including at least one of LCH priority, resource type for a UE (or MAC entity) and allowed resource type for each logical channel after the UE receives the configuration. If an LCH priority is configured by the RRC signaling, it is considered as an initial value of the LCH priority, which is used until the value is updated by another RRC message or a MAC CE indicating the change of the priority. If the network wants to change priorities of all peer logical channels of a radio bearer by the MAC CE later, it can be configured. After the UE applies the configuration, as act 20-4 both the network and UE perform transmissions and/or reception based on the received configuration including one of LCH priority, resource type for a UE or MAC entity and allowed resource type for each logical channel.

When the network node decides to change at least one of LCH priority of a logical channel and/or resource type, as act 20-5 a MAC CE is sent from the network to the UE. The MAC CE format can be exemplary format shown in FIGS. 17, 18, 19 or other similar format. As act 20-6 the UE applies the LCH priority received in the MAC CE after the UE receives the MAC CE. The LCH priority is used until the value is updated by another RRC message or a MAC CE indicating the change of the priority. After the UE applies the LCH priority, as act 20-7 both the network and UE perform transmissions and/or reception based on the received the latest configuration including one of LCH priority, resource type for a UE (or MAC entity) and allowed resource type for each logical channel.

In the third aspect of the technology disclosed herein, logical channel has been described as an example unit of data flow. However, in some other exemplary embodiment, QoS flow can be used as a unit of data flow. In this case, each QoS flow may have its allowed resource type and QoS flow priority.

The network may need to change one priority value for a data flow to another priority value, by considering whether each QoS flow of the data flow, e.g., logical channel, meets its QoS requirement and/or QoS status, e.g. data rate, delay, etc. In the case of split bearer depicted in FIG. 16, multiple logical channels belonging to the same radio bearer may need to guarantee the same QoS requirements. To resolve this issue, the network may indicate the change of LCH priority of all logical channels for a radio bearer.

FIG. 21 depicts a MAC CE format which indicates the change of LCH priorities for a radio bearer. The MAC CE contains a radio bearer identity, RB ID, field which identifies the corresponding radio bearer and a priority field which indicates the priority value which logical channel of the corresponding radio bearer shall apply. The R field is a reserved bit to have octet (8-bit) alignments. The size of the MAC CE is 2 bytes (16 bits), so it is a fixed-size MAC CE. The sizes of RB ID field and priority field are assumed to be 6 bits and 4 bits, respectively. However, different exemplary embodiments may have different sizes. In some exemplary embodiment, a data radio bearer, DRB, ID may be used as an RB ID.

If a UE receives the MAC CE, the LCH priorities of all logical channels for the same radio bearer will have the same value indicated by the MAC CE.

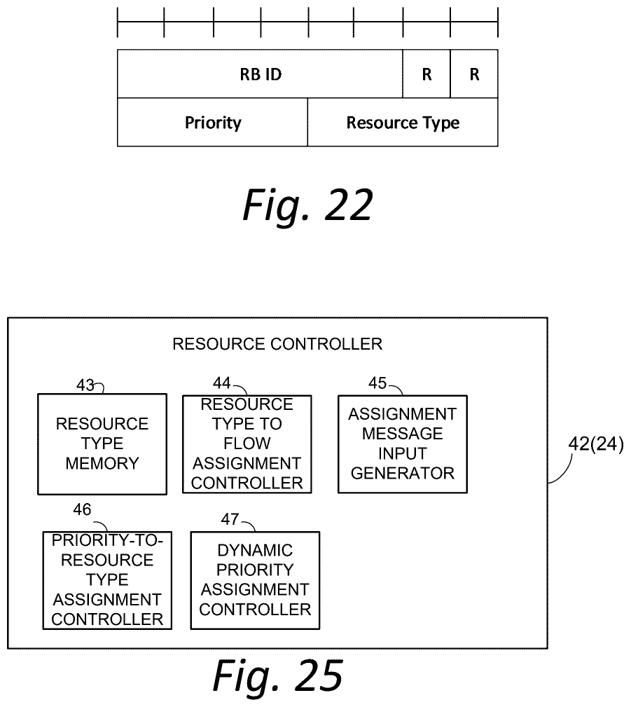

If different resource types have different priority values, a MAC CE can indicate the change of LCH priority for a particular resource type. FIG. 22 depicts a MAC CE format which indicates the change of all LCH priorities for a radio bearer and a resource type. The MAC CE contains RB ID field which identifies the corresponding radio bearer, resource type field which indicates the corresponding resource type index, and priority field which indicates the priority value which logical channel of the corresponding radio bearer shall apply. The R field is a reserved bit to have octet (8-bit) alignments. The size of the MAC CE is 2 bytes (16 bits), so it is a fixed-size MAC CE. The sizes of RB ID field, resource type field and priority field are assumed to be 6 bits, 4 bits and 4 bits, respectively. However, different exemplary embodiments may have different sizes. In some exemplary embodiment, a data radio bearer, DRB, ID may be used as an RB ID.

If a UE receives the MAC CE, the LCH priorities of all logical channels for the same radio bearer for the indicated resource type will have the same value indicated by the MAC CE.

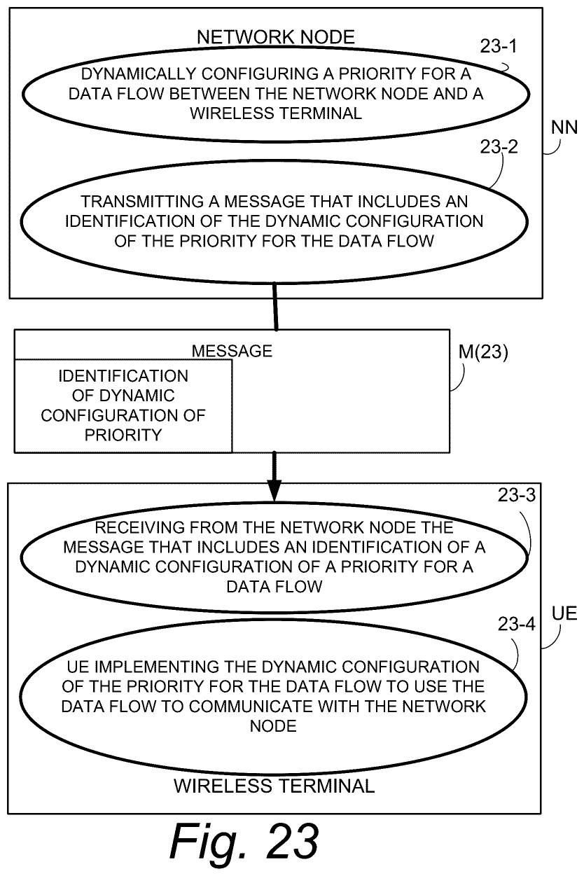

FIG. 23 depicts certain basic, example, representative acts or steps performed in the communications system, e.g., by network node NN and wireless terminal UE, in accordance with the third example aspect of the technology disclosed herein. Such basic acts are now briefly described with reference to acts 23-1 through and including 23-4 and are understood more fully in the context of the ensuing description.

Act 23-1 comprises the network node NN dynamically configuring a priority for a data flow between the network node and a wireless terminal. Act 23-2 comprises the network node NN transmitting, over a radio interface to the wireless terminal, a message M(23) that includes an identification of the dynamic configuration of the priority for the data flow. As used herein, the message M(23) may comprise at least one message, and thus may comprise plural messages to convey the information configured by the network node NN.

Act 23-3 comprises the wireless terminal UE receiving from the network node a message that includes an identification of a dynamic configuration of a priority for a data flow. Act 23-4 comprises the wireless terminal UE implementing the dynamic configuration of the priority for the data flow to use the data flow to communicate with the network node.

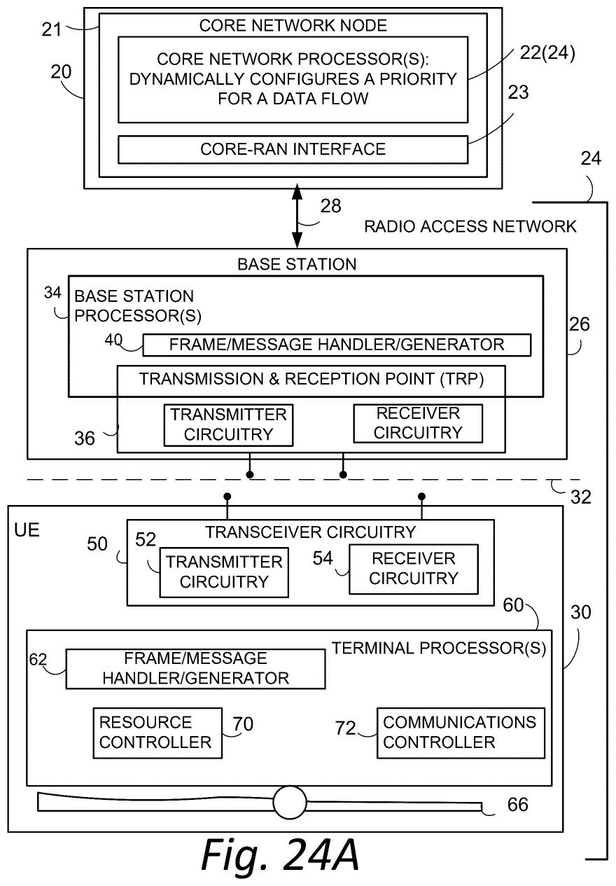

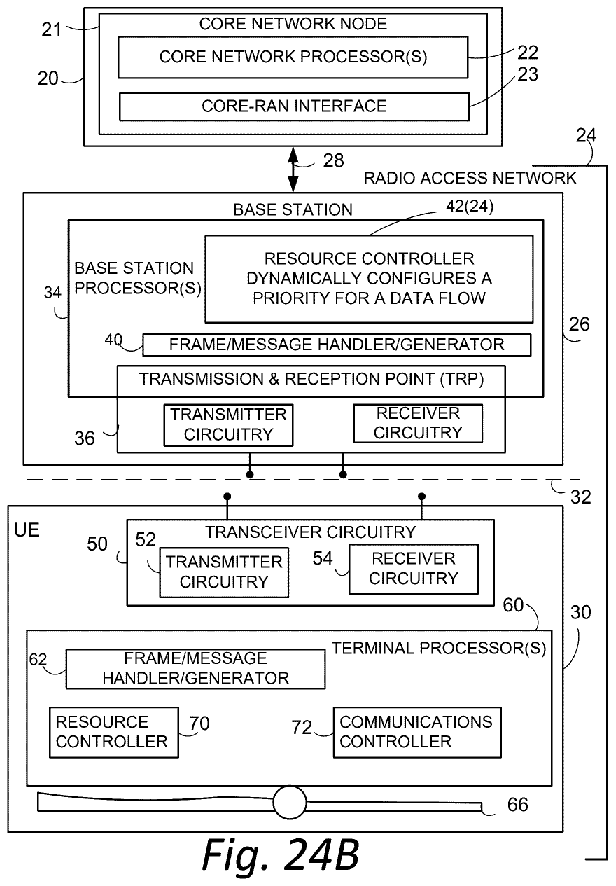

FIG. 24A and FIG. 24B show in more detail example structures and functionalities that may, in respective first and second example embodiments and modes, comprise or be included in the communications network of FIG. 23. In the communications system of FIG. 24A, the network node NN comprises a core network node. By contrast, in the communications system of FIG. 24B, the network node NN comprises a radio access network.

FIG. 24A and FIG. 24B both show that the example communications networks, which may be 5G networks, for example, comprise core network 20. The core network 20 may comprise one or more core network nodes, such as core network node 21. The core network node 21 may comprise or be realized by any suitable type of core network node, such as a core network management entity, e.g., an Access and Mobility Management Function (AMF). One or more of the core network nodes 21 may comprise core node processor circuitry, such as core node processor(s) 22. The core network 20 and one or more of its constituent core network nodes 21 is connected to at least one radio access network 24 through a core-RAN interface circuit 23. The core-RAN interface circuit 23 may be connected to wireline(s) 28.

The radio access network 24 in turn comprises one or more radio access network (RAN) nodes, such as example base station node 26. The base station node 26 serves at least one cell. The radio access network, RAN, 24 typically comprises plural access nodes, one example access node 26 being illustrated as a base station node in FIG. 24A and FIG. 24B.

FIG. 24A and FIG. 24B both show the radio access network 24, and base station node 26 through its cell in particular communicating with wireless terminal 30 across a radio or air interface 32. The base station node 26 may, and usually does, communicate with plural wireless terminals across the air interface 32. Only one wireless terminal 30 is shown for sake of simplicity, it being understood that other wireless terminals may be provided and may operate in similar manner as the wireless terminal 30 herein illustrated.

FIG. 24A and FIG. 24B show base station node 26 as comprising base station processor circuitry which may comprise one or more base station processors 34, as well as base station transceiver circuitry 36. As illustrated in FIG. 24A, the base station transceiver circuitry 36 may be a transmission and reception point (TRP). The transmission and reception point (TRP) 36 may further comprise transmitter circuitry and receiver circuitry. The base station processors 34 may comprise frame/message handler/generator 40 which prepares and generates information including user data and messages, e.g., signaling, for transmission over the radio interface 32, as which also processes information received over the radio interface 32.

The base station node 26 may be structured essentially as shown in FIG. 24A and FIG. 24B may be a node having architecture such as split architecture comprising a central unit and one or more distributed units that comprise mobile termination (MT). The base station processor(s) may include one or more TRPs.

FIG. 24A and FIG. 24B also show various example constituent components and functionalities of wireless terminal 30. For example, FIG. 24A and FIG. 24B show wireless terminal 30 as comprising terminal transceiver circuitry 50. The transceiver circuitry 50 in turn may comprise terminal transmitter circuitry 52 and terminal receiver circuitry 54. The terminal transceiver circuitry 50 may include antenna(e) for the wireless transmission. Terminal transmitter circuitry 52 may include, e.g., amplifier(s), modulation circuitry and other conventional transmission equipment. Terminal receiver circuitry 54 may comprise, e.g., amplifiers, demodulation circuitry, and other conventional receiver equipment.

FIG. 24A and FIG. 24B further show wireless terminal 30 also comprising wireless terminal processor circuitry, e.g., one or more wireless terminal processor(s) 60. The wireless terminal 30, e.g., wireless terminal processor(s) 60, may comprise terminal frame or message handler/generator 62. The wireless terminal 30 may also comprise user interfaces 66, including one or more user interfaces. Such user interfaces may serve for both user input and output operations, and may comprise (for example) a keyboard, a mouse, a screen such as a touch screen that can both display information to the user and receive information entered by the user. The user interface 66 may also include other types of devices, such as a speaker, a microphone, or a haptic feedback device, for example.

In the example embodiment and mode of FIG. 24A the network node NN which performs acts such as act 23-1 through and including act 23-2 of FIG. 23 is a core network node, such as core network node 21 of FIG. 24A. FIG. 24A particularly shows the core node processor(s) 22(24) of core network node 21 which dynamically configures a priority for a data flow between the network node and a wireless terminal. Further, in the example embodiment and mode of FIG. 24A, the core-RAN interface circuit 23 is the interface that, under direction of core node processor(s) 22, transmits the message(s) M(23) which includes an identification of the dynamic configuration of the priority for the data flow of the data flow to the wireless terminal 30. It should be understood that the message M(23) in the example embodiment and mode of FIG. 24A is eventually transmitted to wireless terminal 30 through the radio access network, e.g., in which case the message M may be modified for the protocols utilized in communications between the radio access network and the wireless terminal 30.

In the example embodiment and mode of FIG. 24B the network node NN which performs acts such as act 23-1 through and including act 23-2 of FIG. 23 is a radio access network node, such as radio access network node 26 of FIG. 24B. FIG. 24B particularly shows that the base station processor(s) 34 of base station node 26 comprise resource controller 42(24) which serves to dynamically configure a resource type for a data flow between the network node and a wireless terminal. Further, in the example embodiment and mode of FIG. 24B, the base station transceiver circuitry 36, under direction of base station processor(s) 34, transmits the message(s) M(23) which includes the identification of the dynamic configuration of the priority for the data flow to the wireless terminal 30.

FIG. 25 shows example units or functionalities that may comprise resource controller 42(24) in an example, non-limiting example embodiment and mode. As shown in FIG. 25, resource controller 42(24) may comprise resource type memory 43; resource type-to-data flow assignment controller 44; priority-to-resource type assignment controller 46, and assignment message input generator 45, each of which are described in conjunction with the first aspect of the technology disclosed herein. In addition, resource controller 42(12) may comprise dynamic priority assignment controller 47. The priority-to-resource type assignment controller 46 may dynamically configure a priority for a data flow between the network node and a wireless terminal. Upon completion of the assignments by dynamic priority assignment controller 47, assignment message input generator 45 may generate a message or input to for preparation of a message that will communicate the dynamic configuration of the priority for the data flow to the wireless terminal 30As indicated previously, assignment message input generator 45 may either prepare the message M, or may prepare information that may be used by frame/message handler/generator 40 to generate the message M(23).

Although the example resource controller 42(24) of FIG. 25 has been discussed primarily with reference to a radio access network node, it should be understood that similar units and functionalities may also be included in an example embodiment and mode in which the core node processor(s) 22(24) function as the resource controller.

The wireless terminal 30 of both FIG. 24A and FIG. 24B may perform the acts 23-3 through and including 23-4 of FIG. 23. In particular the wireless terminal processor(s) 60 may be involved in performing act 23-4, for example. The wireless terminal processor(s) 60 are configured to perform many functions for operation of the wireless terminal in general, as known to the person skilled in the art. For performing functions germane to the technology disclosed herein, in an example embodiment and mode the wireless terminal processor(s) 60 may be structured or configured to comprise or realize several functionalities or units including resource controller 70 and communications controller 72. The resource controller 70 serves, e.g., to apply the received resource assignments to the data flows. The communications controller 72 serves, e.g., to generate and process information included in the data flows.

### Further Considerations

It should be understood that the various foregoing example embodiments and modes may be utilized in conjunction with one or more example embodiments and modes described herein. For example, the example embodiments and modes of all three aspects of the technology disclosed herein, e.g., FIG. 6, FIG. 12, and FIG. 23, may be utilized in combination with one or more other example embodiments and modes disclosed herein.

Certain units and functionalities of the communications systems may be implemented by electronic machinery. For example, electronic machinery may refer to the processor circuitry described herein, such as core node processor(s) 22, base station processors 34, and wireless terminal processor(s) 60. Moreover, the term “processor circuitry” is not limited to mean one processor, but may include plural processors, with the plural processors operating at one or more sites. Moreover, as used herein the term “server” is not confined to one server unit but may encompass plural servers and/or other electronic equipment and may be co-located at one site or distributed to different sites. With these understandings, FIG. 26 shows an example of electronic machinery, e.g., processor circuitry, as comprising one or more processors 490, program instruction memory 492; other memory 494 (e.g., RAM, cache, etc.); input/output interfaces 496 and 497, peripheral interfaces 498; support circuits 499; and busses 500 for communication between the aforementioned units. The processor(s) 490 may comprise the processor circuitries described herein, for example, core node processor(s) 22, base station processors 34, and wireless terminal processor(s) 60.

A memory or register described herein may be depicted by memory 194, or any computer-readable medium, may be one or more of readily available memory such as random access memory (RAM), read only memory (ROM), floppy disk, hard disk, flash memory or any other form of digital storage, local or remote, and is preferably of non-volatile nature, as and such may comprise memory. The support circuits 499 are coupled to the processors 490 for supporting the processor in a conventional manner. These circuits include cache, power supplies, clock circuits, input/output circuitry and subsystems, and the like.

The processes and methods of the disclosed embodiments may be implemented as a software routine. Alternatively or additionally, some or all of method steps that are disclosed therein may be performed in hardware as well as by a processor running software. As such, the embodiments may be implemented in software, as executed upon a computer system, in hardware as an application specific integrated circuit or other type of hardware implementation, or a combination of software and hardware. The software routines of the disclosed embodiments are capable of being executed on any computer operating system and is capable of being performed using any CPU architecture.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus, machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” may also be construed to refer to other hardware capable of performing such functions and/or executing software, such as the example hardware recited above.

Nodes that communicate using the air interface also have suitable radio communications circuitry. Moreover, the technology disclosed herein may additionally be considered to be embodied entirely within any form of computer-readable memory, such as solid-state memory, magnetic disk, or optical disk containing an appropriate set of computer instructions that would cause a processor to carry out the techniques described herein.

The acts described herein, including but not limited to the acts of FIG. 6, FIG. 12, and FIG. 23, may be performed by a software program product stored tangibly on a non-transient computer-readable medium which, when executed by one or more processors as herein mentioned, performs such acts either in whole or in part.

Moreover, each functional block or various features of the wireless terminal 30, core network node 21, and base station node 26 employed in each of the aforementioned embodiments may be implemented or executed by circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

It will be appreciated that the technology disclosed herein is directed to solving radio communications-centric issues and is necessarily rooted in computer technology and overcomes problems specifically arising in radio communications. Moreover, the technology disclosed herein improves resource selection and resource utilization in a communications system.

The technology disclosed herein encompasses one or more of the following non-limiting, non-exclusive example embodiments and modes:
Example Embodiment 1-1: A network node of a telecommunications system, the network node comprising:
processor circuitry configured to configure plural resource types for a data flow between the network node and a wireless terminal; and
interface circuitry configured to transmit, over a radio interface to the wireless terminal, a message that identifies the plural resource types for the data flow.
Example Embodiment 1-2: The network node of Example Embodiment 1-1, wherein the message includes an identifier of each of the plural resource types.
Example Embodiment 1-3: The network node of Example Embodiment 1-2, wherein each identifier comprises an index.
Example Embodiment 1-4: The network node of Example Embodiment 1-1, wherein the message includes an uplink grant.
Example Embodiment 1-5: The network node of Example Embodiment 1-1, wherein the data flow is a logical channel (LCH) or quality of service (QoS) flow.
Example Embodiment 1-6: The network node of Example Embodiment 1-1, wherein the message comprises a radio resource control (RRC) message.
Example Embodiment 1-7: The network node of Example Embodiment 1-1, wherein the processor circuitry is configured to dynamically grant plural resource types for the data flow, and wherein the interface circuitry is configured to transmit a message using physical layer control signaling to provide an indication of the dynamic grant to the wireless terminal.
Example Embodiment 1-8: The network node of Example Embodiment 1-7, wherein the indication of the dynamic grant comprises downlink control information (DCI).
Example Embodiment 1-9: A method in a network node of a telecommunications system, the method comprising:
configuring plural resource types for a data flow between the network node and a wireless terminal;
transmitting, over a radio interface to the wireless terminal, a message that identifies the plural resource types for the data flow.
Example Embodiment 1-10: A wireless terminal which communicates with a network node through a radio access network, the wireless terminal comprising:
interface circuitry configured to receive from the network node a message that identifies plural resource types for a data flow between the network node and the wireless terminal;
processor circuitry configured to determine the plural resource types for the data flow from the message and to use the plural resource types for the data flow to communicate with the network node over the data flow.
Example Embodiment 1-11: The wireless terminal of Example Embodiment 1-10, wherein the message includes an identifier of each of the plural resource types.
Example Embodiment 1-12: The wireless terminal of Example Embodiment 1-11, wherein each identifier comprises an index.
Example Embodiment 1-13: The wireless terminal of Example Embodiment 1-10, wherein the message includes an uplink grant.
Example Embodiment 1-14: The wireless terminal of Example Embodiment 1-10, wherein the data flow is a logical channel (LCH) or quality of service (QoS) flow.
Example Embodiment 1-15: The wireless terminal of Example Embodiment 1-10, wherein the message comprises a radio resource control (RRC) message.
Example Embodiment 1-16: The wireless terminal of Example Embodiment 1-10, wherein the interface circuitry is configured to receive an indication of a dynamic grant of plural resource types for the data flow, and wherein the processor circuitry is configured to determine the plural resource types for the data flow from the indication of the dynamic grant and to use the plural resource types for the data flow to communicate with the network node over the data flow.
Example Embodiment 1-17: The wireless terminal of Example Embodiment 1-16, wherein the indication of the dynamic grant comprises downlink control information (DCI).
Example Embodiment 2-1: A network node of a telecommunications system, the network node comprising:
processor circuitry configured to configure:
   plural resource types for a data flow between the network node and a wireless terminal; and
   differing priorities for at least two of the resource types of the data flow; and
interface circuitry configured to transmit, over a radio interface to the wireless terminal, a message that identifies the plural resource types for the data flow and the differing priorities for the at least two of the resource types of the data flow.
Example Embodiment 2-2: The network node of Example Embodiment 2-1, wherein the differing priorities of the at least two resource types of the data flow are configured in dependence on the respective resource type.
Example Embodiment 2-3: The network node of Example Embodiment 2-1, wherein the message includes an uplink grant.
Example Embodiment 2-4: The network node of Example Embodiment 2-1, wherein the data flow is a logical channel (LCH) or quality of service (QoS) flow.
Example Embodiment 2-5: The network node of Example Embodiment 2-1, wherein the message comprises a radio resource control (RRC) message.
Example Embodiment 2-6: A method in a network node of a telecommunications system, the method comprising:
configuring plural resource types for a data flow between the network node and a wireless terminal;
configuring differing priorities for at least two of the resource types of the data flow;
transmitting, over a radio interface to the wireless terminal, a message that identifies the plural resource types for the data flow and the differing priorities for the at least two of the resource types of the data flow.
Example Embodiment 2-7: A wireless terminal which communicates with a network node through a radio access network, the wireless terminal comprising:
interface circuitry configured to receive from the network node a message that identifies:
   plural resource types for a data flow between the network node and the wireless terminal;
   differing priorities for at least two of the resource types of the data flow; processor circuitry configured to
   determine the plural resource types for the data flow and the differing priorities for at least two of the resource types of the data flow from the message;
   to use the plural resource types for the data flow and the priority of the at least one resource type of the data flow to communicate with the network node over the data flow.
Example Embodiment 2-8: The wireless terminal of Example Embodiment 2-7, wherein the differing priorities for at least two of the resource types of the data flow are configured in dependence on the resource type.
Example Embodiment 2-9: The wireless terminal Example Embodiment 2-7, wherein the message includes an uplink grant.
Example Embodiment 2-10: The wireless terminal of Example Embodiment 2-7, wherein the data flow is a logical channel (LCH) or quality of service (QoS) flow.
Example Embodiment 2-11: The wireless terminal of Example Embodiment 2-7, wherein the message comprises a radio resource control (RRC) message.
Example Embodiment 3-1: A network node of a telecommunications system, the network node comprising:
processor circuitry configured to dynamically configure a priority for a data flow between the network node and a wireless terminal; and
interface circuitry configured to transmit, over a radio interface to the wireless terminal, a message that includes an identification of the dynamic configuration of the priority for the data flow.
Example Embodiment 3-2: The network node of Example Embodiment 3-1, wherein the identification of the dynamic configuration of the priority for the data flow is included in a medium access control (MAC) control element (CE).
Example Embodiment 3-3: The network node of Example Embodiment 3-1, wherein the data flow is a logical channel (LCH) or quality of service (QoS) flow.
Example Embodiment 3-4: The network node of Example Embodiment 3-1, wherein the identification of the dynamic configuration of the priority for the data flow comprises a medium access control—control element (MAC CE), and wherein when the data flow is one of plural data flows belonging to a same radio bearer, the processor circuitry generates a second message to change priority of a peer data flow that belongs to the same radio bearer.
Example Embodiment 3-5: The network node of Example Embodiment 3-4, wherein the second message comprises a radio resource control message.
Example Embodiment 3-6: A method in a network node of a telecommunications system, the method comprising:
dynamically configuring a priority for a data flow between the network node and a wireless terminal; and
transmitting, over a radio interface to the wireless terminal, a message that includes an identification of dynamic configuration of the priority for the data flow.
Example Embodiment 3-7: A wireless terminal which communicates with a network node through a radio access network, the wireless terminal comprising:
interface circuitry configured to receive from the network node a message that includes an identification of a dynamic configuration of a priority for a data flow;
processor circuitry configured to implement the dynamic configuration of the priority for the data flow to use the data flow to communicate with the network node.
Example Embodiment 3-8: The wireless terminal of Example Embodiment 3-7, wherein the identification of the dynamic configuration of the priority for the data flow is received in a medium access control (MAC) control element (CE).
Example Embodiment 3-9: The wireless terminal of Example Embodiment 3-7, wherein the data flow is a logical channel (LCH) or quality of service (QoS) flow.
Example Embodiment 3-10: The wireless terminal of Example Embodiment 3-7, wherein the identification of the dynamic configuration of the priority for the data flow comprises a medium access control—control element (MAC CE), and wherein when the data flow is one of plural data flows belonging to a same radio bearer, the interface circuitry receives a second message to change priority of a peer data flow that belongs to the same radio bearer.

Although the description above contains many specificities, these should not be construed as limiting the scope of the technology disclosed herein but as merely providing illustrations of some of the presently preferred embodiments of the technology disclosed herein. Thus the scope of the technology disclosed herein should be determined by the appended claims and their legal equivalents. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an element in the singular is not intended to mean “one and only one” unless explicitly so stated, but rather “one or more.” The above-described embodiments could be combined with one another. All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims.

What is claimed is:

1. A network node of a telecommunications system, the network node comprising:
processor circuitry configured to configure:
plural resource types for a data flow between the network node and a wireless terminal; and
differing priorities for at least two of the resource types of the data flow; and
interface circuitry configured to transmit, over a radio interface to the wireless terminal, a message that identifies the plural resource types for the data flow and the differing priorities for the at least two of the resource types of the data flow.

2. The network node of claim 1, wherein the differing priorities of the at least two resource types of the data flow are configured in dependence on the respective resource type.

3. The network node of claim 1, wherein the message includes an uplink grant.

4. The network node of claim 1, wherein the data flow is a logical channel (LCH) or quality of service (QoS) flow.

5. The network node of claim 1, wherein the message comprises a radio resource control (RRC) message.

6. A method in a network node of a telecommunications system, the method comprising:
configuring plural resource types for a data flow between the network node and a wireless terminal;
configuring differing priorities for at least two of the resource types of the data flow;
transmitting, over a radio interface to the wireless terminal, a message that identifies the plural resource types for the data flow and the differing priorities for the at least two of the resource types of the data flow.

7. A wireless terminal which communicates with a network node through a radio access network, the wireless terminal comprising:
interface circuitry configured to receive from the network node a message that identifies:
plural resource types for a data flow between the network node and the wireless terminal;
differing priorities for at least two of the resource types of the data flow;
processor circuitry configured to
determine the plural resource types for the data flow and the differing priorities for at least two of the resource types of the data flow from the message;
to use the plural resource types for the data flow and the priority of the at least one resource type of the data flow to communicate with the network node over the data flow.

8. The wireless terminal of claim 7, wherein the differing priorities for at least two of the resource types of the data flow are configured in dependence on the resource type.

9. The wireless terminal claim 7, wherein the message includes an uplink grant.

10. The wireless terminal of claim 7, wherein the data flow is a logical channel (LCH) or quality of service (QoS) flow.

11. The wireless terminal of claim 7, wherein the message comprises a radio resource control (RRC) message.
